(19) United States
(12) Patent Application Publication
(10) Pub. No.: US 2025/0200050 A1
(43) Pub. Date: Jun. 19, 2025

(54) MODEL-ENABLED DATA PIPELINE GENERATION

(71) Applicant: C3.ai, Inc., Redwood City, CA (US)

(72) Inventors: Prateek Prashant TENKALE, San Mateo, CA (US); Joshua Jiayi SI, Saratoga, CA (US)

(21) Appl. No.: 18/980,861

(22) Filed: Dec. 13, 2024

Related U.S. Application Data
(60) Provisional application No. 63/610,258, filed on Dec. 14, 2023.

(51) Int. Cl. G06F 16/2455; G06F 16/242

(52) U.S. Cl. CPC G06F 16/24568; G06F 16/243

(57) ABSTRACT

Disclosed herein are system, method, and computer program product aspects for generating a data pipeline. A model prompt including a received natural language description and a prompt template is generated. The prompt template includes action labels and a processing example. Each action label indicates a respective data processing action, and the processing example includes a sample query and a sample answer comprising one or more sample action labels associated with a sample natural language description of a sample data pipeline. A multimodal model (MM) is queried with the model prompt. The MM response includes one or more action labels corresponding to the natural language description of the requested data pipeline in a format guided by the prompt template. A data pipeline project template can then be generated using one or more executable nodes corresponding to the action labels.

### CROSS-REFERENCE TO RELATED APPLICATIONS

This application claims the benefit of U.S. Provisional Application No. 63/610,258, filed Dec. 14, 2023, the disclosure of which is incorporated by reference herein in its entirety.

### BACKGROUND

Various systems have been developed that allow users to define desired logic operations graphically. Without having much of knowledge about how to write code that implements a data pipeline, a user can graphically select and connect nodes representing data pipelines, and provide other node information to define the data pipeline. These systems can convert the nodes and the other node information into actual code in an internal system logic for implementing the data pipeline independent of exposure to the user.

### SUMMARY

This disclosure relates to data pipeline generation using machine learning-based platforms or other platforms using multimodal models.

Other technical features may be readily apparent to one skilled in the art from the following figures, descriptions, and claims.

### BRIEF DESCRIPTION OF THE FIGURES

The accompanying drawings are incorporated herein and form a part of the specification.

FIG. 1 is an overview of a workflow of a data pipeline generation system, according to aspects of the present disclosure.

FIG. 2 is a block diagram of a data pipeline generation system, according to aspects of the present disclosure.

FIG. 3 is an operational framework of a data pipeline generation system, according to aspects of the present disclosure.

FIG. 4 is an example illustrating a preprocessing stage and runtime stage of a data pipeline generation system, according to aspects of the present disclosure.

FIG. 5 is an example illustrating a prompt used to query a multimodal model (MM) by a data pipeline generation system, according to aspects of the present disclosure.

FIG. 6 is an example illustrating a process flow associated with project template generation performed by a data pipeline generation system, according to aspects of the present disclosure.

FIG. 7 is an example illustrating a process flow associated with project template generation performed by a data pipeline generation system, according to aspects of the present disclosure.

FIG. 8 is an example illustrating a graphical user interface associated with project template generation performed by a data pipeline generation system, according to aspects of the present disclosure.

FIG. 9 is an example illustrating a graphical user interface associated with project template generation performed by a data pipeline generation system, according to aspects of the present disclosure.

FIG. 10 is an example illustrating a graphical user interface associated with project template generation performed by a data pipeline generation system, according to aspects of the present disclosure.

FIG. 11 is a flowchart illustrating a method for generating a data pipeline, according to aspects of the present disclosure.

FIG. 12 is a flowchart illustrating a method for generating one or more action labels and one or more data source labels associated with the one or more action labels, according to aspects of the present disclosure.

FIG. 13 is a flowchart illustrating a method for rendering a graphical user interface, according to aspects of the present disclosure.

FIG. 14 illustrates an example computer system useful for implementing various aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

A data pipeline is a system for transforming, processing, and/or storing data, and includes a set of operations to be performed using one or more datasets. Typically, when a data pipeline is to be built, code for performing the various operations of the data pipeline is assembled and arranged. Generative systems may assist with identifying and generating such code. For example, some machine learning models have been trained on code snippets that, when executed, perform particular tasks. A user may input a natural language query describing a task into a large language model (LLM), for example, and the LLM may return to the user a code snippet that is expected to perform the task. In some cases, the LLM may return to the user a full program having code that purportedly performs a series of tasks. Such LLMs are limited, however, to information with which they have already been provided. The LLMs may not have access to information that is private or proprietary, or which may be more recent than the information on which the LLM was trained. Due to the computational overhead required for training, such an LLM is not agile enough to respond quickly to technological development or changes, or improved code availability.

Further, many LLMs operate based on a statistical prediction model, such that a returned response is merely a collection of words or phrases that are most likely to appear with each other in similar contexts as the query. Because of this, the query response may not be an operable section of code, may not be compatible with other code sections, may not be optimized for the user's system, platform, or purpose, and/or may be generated differently and inconsistently with each query received. These limitations can undermine reliability, as one cannot be sure that information provided by an LLM is complete, relevant, feasible, consistent, or true.

Aspects described herein solve such technological challenges. Data processing actions, inputs, or outputs associated with a data pipeline may be performed by different “nodes” in the data pipeline. Each node corresponds to actual code that, when executed, performs the particular data processing action, input, or output. The arrangement of and connection between nodes of the data pipeline, whether actively displayed via a visualization tool and/or maintained virtually as a proxy for the underlying software code, may be referred to herein as a “project template” for the data pipeline. In an environment where the nodes corresponding to various data pipeline operations and their associated code are maintained as private or proprietary, the data pipeline operations are represented by higher-level data processing descriptors, referred to herein as action labels. Each action label corresponds to a particular node. A prompt for a multimodal model (MM), such as an LLM, is constructed by a data pipeline generation system from a prompt template (also referred to herein as a prompt prefix) and a natural language description of the data pipeline to be generated. The prompt template includes a set of available action labels corresponding to the pipeline generation system's own proprietary or private nodes, and one or more examples providing context for the MM to select action labels from the set that are applicable to the natural language query. As a result, instead of actual code snippets, the MM generates a set of action labels in an order corresponding to the desired data pipeline. Upon receipt of the action labels corresponding to the data pipeline from the MM, the received action labels are mapped to the platform's own corresponding nodes. A project template may then be generated using the nodes, with the layout of and interconnections between the nodes arranged in accordance with the order of action labels provided by the MM. The project template may then be used to customize, revise, and/or test the data pipeline. Once ready for production, the nodes in the project template may be converted to their corresponding software code for performing the associated data processing actions, inputs, or outputs of the data pipeline. The resulting combination of software code elements according to the nodes' arrangement and configuration as finalized using the project template allows a complete executable software program for the data pipeline to be generated without providing any of the underlying code to the MM. This allows for use of optimized but proprietary or platform-specific code in the data pipeline, easy code updates on the backend, and consistent results that have already been validated and whose operation and interoperability have been confirmed.

Once a project template is generated for a particular data pipeline, the template may be stored and made available for future use for the same or similar data pipelines.

In some aspects, the MM may additionally provide a data source label corresponding to each returned action label. The data source labels may identify each unique data source and distinguish it from other data sources. When the action labels are mapped to the platform's own nodes, the data source labels may also be mapped to data sources to be used by their respective nodes. When multiple datasets might originate from the same origin, this helps to maintain consistency and clarity in the data analysis, and facilitates tracking and management of the data sources. The data source label may also enable an effective communication between developers or users by providing context for data origin.

To improve contextual understanding of the user query, the data pipeline generation system may orchestrate prompts by asking or clarifying follow-up questions or queries before finalizing the MM prompt. For example, an additional MM query may be used during prompt orchestration to refine the context (e.g., natural language description of the data pipeline) before actually querying the MM to generate the project template and/or data pipeline.

Compared to training or fine-tuning an MM using traditional means, modifying a model prompt to include a prompt prefix in addition to the user's query may increase memory efficiency of the data pipeline generation system. Rather than storing a full copy of the pre-trained or fine-tuned MM for generating the data pipeline, only the initial prompt prefix with a smaller size may need to be retained—this may not only conserve storage but may also facilitate scaling to handle a multitude of tasks efficiently.

Use of a data pipeline generation system as described herein may also address data privacy challenges of prior code-generation tools. The challenges can be due to prior tools' requirements to disclose source code for generating and/or configuring elements in a data pipeline, such that similar code may be returned by the model. Aspects described herein solve such data privacy issues by identifying the specific types of nodes that are available for use by the pipeline generation system without disclosing the specific code executed by those nodes. That is, the MM may reply to the prompt without having any understanding of the specific code executed by the various types of nodes in order to process the natural language descriptions, because the prompt identifies the types of nodes available based on their intended functions at a high level without disclosing any code details. Specifically, the prompt can include a few keywords (e.g., action labels and/or data source labels) corresponding to each of the nodes that may be sufficient for an MM to produce a result independent of the underlying code.

In some aspects, when a user of an enterprise data system wishes to design a data pipeline for a particular use case, the user may interface with a system that enables the building, testing, and operation of such a data pipeline. An example of such a data pipeline generation system is the EX MACHINA platform developed by C3.ai of Redwood City, CA. A data pipeline generation system for the enterprise may retain the actual node information (e.g., code modules) such that the underlying code is accessible only by the enterprise platform or system, and not by a third-party MM. Instead of using the MM to return executable code, which may be inoperable, incompatible, unoptimized, or out-of-date on the enterprise platform, aspects described herein guide the MM to generate and return a higher-level process flow. This higher-level process flow can then be used to construct the data pipeline from the proprietary and/or platform-specific nodes by matching the action labels in the MM response to nodes available for pipeline generation at the enterprise platform. This also allows updates and additions to be made to the code underlying the platform's nodes without needing such code to propagate through the MM.

Such a data pipeline generation system may allow users to define or update desired logic operations using the system's graphical user interface, while still benefitting from the project template generation capabilities of the MM. Once the project template has been generated and a proposed data pipeline has been translated onto the platform interface's canvas, a user can interact with or edit nodes representing known logical operations on a canvas of the graphical user interface, such as via “drag and drop” operations. The system may also have an interactive mode for the users to provide any user instructions to refine the generated project template. Within the interactive mode, the user can connect the nodes via the canvas and provide other information in order to define a complete data pipeline. The system can then convert the nodes and the other information provided by the user into actual code in the internal system logic for implementing the complete data pipeline. In some aspects, the user may provide the instructions in natural language or any other modalities. As such, based on the user inputs, the accuracy and/or user comfort of generating and/or updating the project template (e.g., in a graphical way) may be maintained while also allowing project templates to be generated in a semi or fully-automated manner. In addition, once the project templates are defined and/or generated, the system may automatically export and/or upload the project templates to other systems or platforms, where users may make any further desired modifications re-generating the project templates from scratch.

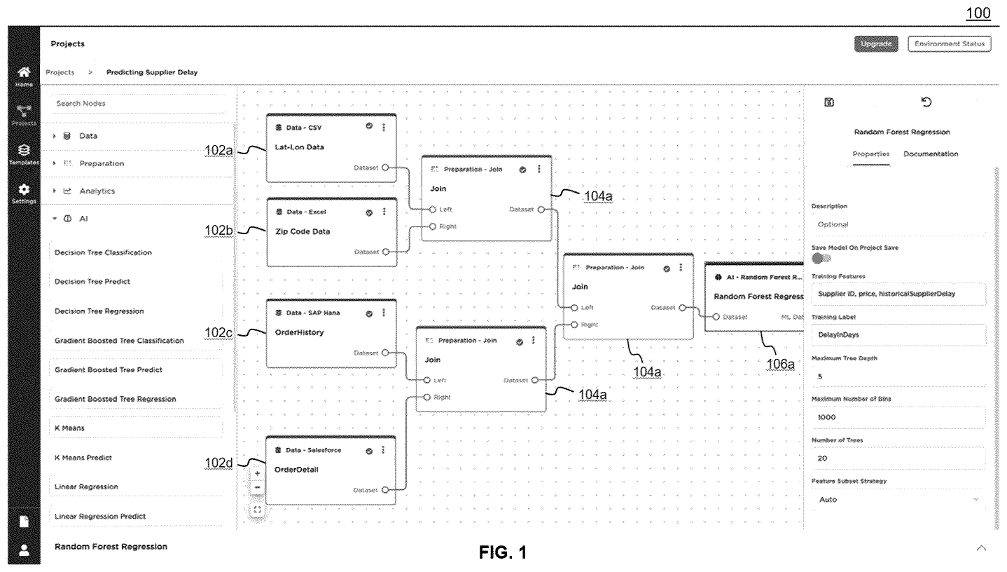

FIG. 1 illustrates a user interface 100 for building a data pipeline on an enterprise platform, according to aspects of the present disclosure. Each box on a canvas (e.g., grid) of interface 100 represents a node in the data pipeline, and the collection of nodes constitutes a project template. By selecting specific nodes and connecting them together, the user can create a project template of a data pipeline that follows the data processing path from input through to output or other completion. A node may include code that, when executed, performs the respective data processing action or otherwise identifies the input or output. Once the project template is finalized (e.g., all parameters are set and the arrangement of/connections between nodes are acceptable), the project template may be converted to executable code based on the arrangement of and interconnection between the nodes therein. In this way, the system effectively creates a computer program that, when executed, performs the designed data pipeline.

Nodes may include, but are not limited to, a data connection and/or a data operation. Data operations may include, but are not limited to, importing data, such as from one or more external data sources; data preparation, such as performing one or more transformations on the data, such as filtering the data, selecting or dropping the data, sorting the data, or grouping/aggregating the data (any of which may be based on one or more suitable criteria); imputation of data, such as to fill in missing data; data analysis, such as computing statistics on columns or other subsets or all of the data; data visualization, such as generating one or more graphs or other interfaces; performing regression, classification, or other operations using one or more artificial intelligence (AI)/machine learning (ML) algorithms; and/or exporting data, such as to one or more external data sources (which may or may not be the same as the one or more external data sources used for importing data). Data operations may also include data validation, which is the process of testing and verifying that data is correct and usable.

User interface 100 may be a drag-and-drop interface that allows a user to develop analytics on selected input data. Interface 100 may visualize nodes accessible to the pipeline, shown in the menu on the left. Interface 100 may also allow a user to customize individual nodes, such as is shown in the information box on the right. Such an interface allows for connecting to common enterprise and operational data stores, preparing and blending data without writing code, visualizing data at any step in the pipeline, analyzing data using machine learning and artificial intelligence (AI) algorithms developing new insights, and/or operationalizing insights using cloud-scale services or systems.

In some aspects, at certain data connections, data may be loaded from one or more data sources, file systems, file sharing systems, integration services, and/or enterprise and operational systems or data stores. For example, the one or more data sources may include an input file, such as comma-separated values (CSV) file 102a and/or a spreadsheet file 102b. File systems may include, for example and without limitation, HADOOP distributed file system (HDFS) from the Apache Software Foundation of Wilmington, DE, S3 from Amazon.com, Inc. of Seattle, WA, and/or AZURE DATA LAKE from Microsoft Corp. of Redmond, WA. File sharing systems may include, for example and without limitation, BOX from Box Inc. of Redwood City, CA. Integration services may include, for example and without limitation, weather data. Enterprise and operational systems or data stores may include, for example and without limitation, the DATABRICKS platform from Databricks, Inc. of San Francisco, CA, SAP HANA (102c) from SAP SE of Waldorf, Germany, the SALESFORCE platform (102d) from Salesforce, Inc. of San Francisco, CA, and/or the SNOWFLAKE platform from Snowflake, Inc. of Bozeman, MT.

Data preparation for the connected or loaded data may include discovering, cleansing, enriching, and/or validating the data, making the data ready for subsequent analysis. Data preparation may include operations such as, for example and without limitation, join 104a, merge, limit, shift, filter by structured query language (SQL), split by randomness, and/or other operations. Data preparation may also include data wrangling operations such as rename columns, sort columns, convert column field type, etc. Data preparation may also include processing of time series data such as time adjust time series, normalize time series, perform rolling window, etc. In addition, data preparation may include math operations such as group by, pivot, etc.

User interface 100 may allow visualization of data at any step in the workflow to understand data formats, completeness, and/or accuracy. Such data visualization may include, for example and without limitation, a bar chart, a line chart, a correlation matrix, and/or any geospatial visualization.

Generating a project template that is later converted to executable code allows for data and/or pipeline validation in a simulation prior to code execution. Data validation may include using the nodes to validate or test with sample data and/or parmaeters; compare output results with expected results; and/or define data quality metrics, such as measurement metrics including accuracy, completeness, consistency, and timeliness. Data validation may also include implementing a real-time validation test to fix inaccuracies as they occur. In some aspects, data validation is a type of data cleansing that may help ensure data is reliable and valid for analysis. For example, data validation may include a data type validation such as verifying that the characters entered by a user match the expected characters for a data type; a data syntax validation, such as focusing on the structure and format of the data; and a data integrity validation, such as verifying the consistency and integrity of data across multiple data sources or within a single data source.

In some aspects, for data analysis, user interface 100 may be used to build analytic pipelines, analyze data using a machine learning or AI pipeline, and/or test the prediction performance of various algorithms. For example and without limitation, the machine learning or AI pipeline may include clustering algorithms, classification algorithms, and/or regression algorithms. The clustering algorithms may include, for example and without limitation, KMeans and Gaussian mixture models. The classification algorithms may include, for example and without limitation, logistic regression, decision tree, gradient boosted tree, and random forest. The regression algorithms may include, for example and without limitation, random forest 106a, linear regression and principal component analysis. When building an AI related analytics pipeline, user interface 100 may allow the user to identify training features, training labels, and/or other model or training configurations, parameters, and/or properties.

For data operation, insights may be shared with any cloud-scale infrastructure, and results written to production applications. For example, data operations may include, but are not limited to, exporting results to file systems, integration services, or enterprise systems via a prebuilt connectors, scaling resources up or down as needed, scheduling projects to execute on a regular basis, and/or collaborate with others on the data pipeline projects.

Aspects described herein improve upon such a pipeline builder interface by incorporating natural language processing and MM capabilities to guide the building process, while restricting pipeline nodes to those that are available and/or authorized for use on the enterprise platform, that are known to operate for their intended purpose, and that integrate with other pipeline nodes on the enterprise platform. An MM is a ML model that can process and generate multiple types of data, including but not limited to text, images, audio, and/or video. MMs can use complementary information from different modalities to create a more comprehensive understanding of the data.

The system may receive one or more multimodal inputs from a user including, but not limited to, a natural language description of a data pipeline to be created. The user input may be provided to an MM, such as an LLM, along with a model prompt. The model prompt may provide useful information to the MM, including but not limited to identification of different types of nodes that the platform may support and which may be selected for use in the data pipeline. Based on the user input along with the model prompt, the system may query the MM using a one-shot or few-shot process, or an iterative process where the MM may be queried multiple times. The MM may identify the type and order of operations used in the data pipeline. A response from the MM may include, but is not limited to, an identification of specific types of nodes supported by the system that should be used to implement the data pipeline. A project template may be created for the system based on the response, where the project template may include the specific types of nodes and connections between the specific types of nodes. Among other things, this data pipeline generation system can greatly enhance reasoning, knowledge, and contextual understanding of the MM, improve privacy and ease of use, and increase the efficiency at which project templates and data pipelines are designed and/or created on any systems or platforms. These and other aspects of the present disclosure will be described in further detail below with respect to the accompanying drawings.

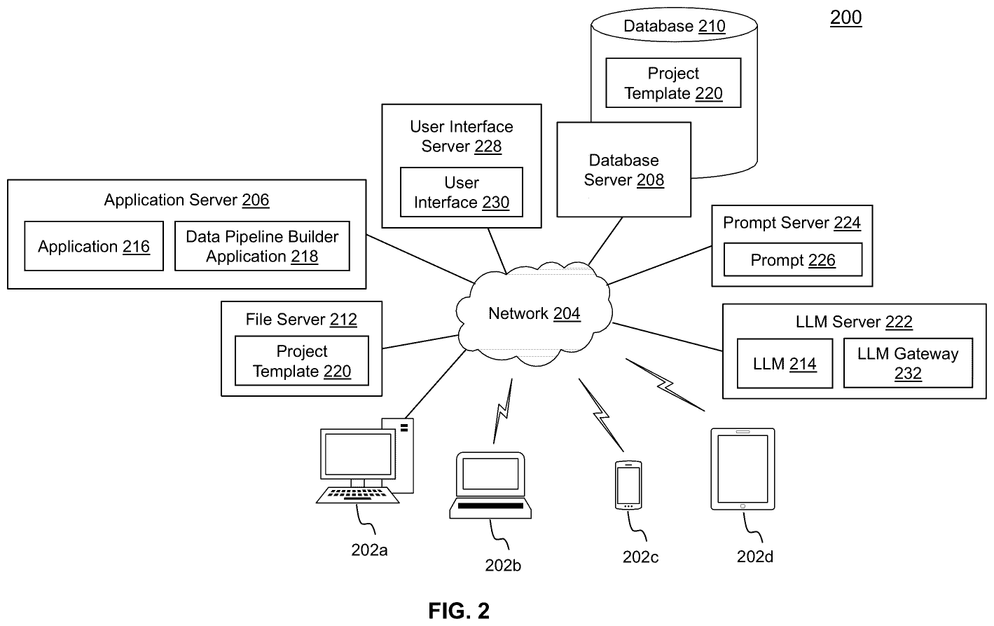

FIG. 2 is a block diagram of a data pipeline generation system 200, according to aspects of the present disclosure. Data pipeline generation system 200 may be used to generate a data pipeline that may be displayed on and/or modified using, for example, user interface 100. While data pipeline generation system 200 will be described with reference to an LLM, a skilled artisan will understand that other types of MMs may additionally or alternatively be used. Data pipeline generation system 200 may include, but is not limited to, one or more user devices 202a-202d, a network 204, an application server 206, a database server 208 associated with a database 210, a file server 212, a prompt server 224, and/or a user interface server 228. Data pipeline generation system 200 may interact with an LLM server, such as LLM server 222. One or more of application server 206, database 210, file server 212, LLM server 222, prompt server 224, and user interface server 228 may be run by the same computing entity, run by a different computing entity, divided between multiple computing entities, or hosted on a cloud computing platform.

One or more user devices 202a-202d may be used by users of data pipeline generation system 200 to create or manage a data pipeline. A user device 202a-202d may communicate with another user device 202a-202d or other components of data pipeline generation system 200 over a network 204 via at least a wired or a wireless connection. A user device 202a-202d may represent a suitable device or system used by at least one user, including but not limited to, a desktop computer, a laptop computer, a smartphone, a tablet computer, and/or any other types of user devices, to provide, receive, and/or exchange information.

Network 204 may facilitate communication between various components of data pipeline generation system 200. For example, network 204 may communicate between network addresses, Internet Protocol (IP) packets, frame relay frames, Asynchronous Transfer Mode (ATM) cells, or other suitable information. Network 204 may also include, but is not limited to, one or more local area networks (LANs), metropolitan area networks (MANs), wide area networks (WANs), a portion of a global network such as the Internet, and/or any other communication systems at one or more geographical locations.

Application server 206 may communicate with database server 208, file server 212, LLM server 222, prompt server 224, and/or user interface server 228 via a facilitated communication built upon network 204. For example, application server 206 may support project template generation using an LLM server 222. Application server 206 may execute one or more applications 216 that may provide data pipelines (e.g., generated from project template 220 in file server 212) to any systems or platforms that allow or support users to define, use, or update those data pipelines.

Associated with application server 206, an application 216 may include or be used in conjunction with a data pipeline builder application 218. Data pipeline builder application 218 may be configured to receive natural language descriptions of data pipelines to be created. Data pipeline builder application 218 may also combine the received natural language descriptions with a prompt identifying the types of nodes that may be used to define the associated data pipeline and/or including examples of how natural language descriptions may be processed to identify nodes for a data pipeline. Such node types may be associated with different types of operations performed by the associated data pipeline.

Data pipeline builder application 218 can provide the natural language description and its associated prompt to query LLM 214 via an LLM gateway 232 of LLM server 222. LLM 214 can then provide a response indicating the specific types of nodes that may be included in the associated data pipeline to be created. For instance, a response from LLM 214 may include, but is not limited to, tokens or labels (e.g., action labels and/or data source labels) identifying the specific types of nodes that should be included in the associated data pipeline to be created. In some aspects, data pipeline builder application 218 can use the response from LLM 214 to create an initial design of the data pipeline. The initial designs can be exported and/or uploaded, as a project template 220, to file server 212 and/or database 210 associated with database server 208.

Database server 208 and/or file server 212 may store and facilitate retrieval of various information used, generated, or collected by application server 206 and user devices 202a-202d. For example, database server 208 and/or file server 212 may store data associated with prompts to be used when querying LLM 214 and project template 220 generated based on the queries to LLM 214. Database server 208 and/or file server 212 may also store any prompt templates retrieved or obtained from prompt server 224 to generate the prompts. In addition, database server 208 and/or file server 212 may be used by application server 206 to store information relating to generating a project template and/or a data pipeline for an application.

LLM server 222 may provide an LLM gateway 232 that may act as an intermediary by channeling requests to query services and handling responses from LLM 214. For example, connected via an LLM gateway 232, LLM 214 can be implemented separately and possibly remote from application server 206. LLM gateway 232 may handle requests from multiple user applications in which different applications may have different requirements. The entity that manages and/or implements LLM 214 may be the same as or different from the entity that manages and/or implements application(s) 216. In some aspects, LLM 214 may be implemented locally to application server 206, in which case LLM 214 can be directly queried without using LLM gateway 232.

Prompt server 224 may provide LLM server 222 with a prompt 226 that may include instructions and/or examples of the desired task. In some aspects, prompt server 224 may provide LLM orchestration that streamlines construction and management of application 216 or data pipeline builder application 218 using LLM 214. For example, prompt server 224 may create, delegate, and/or manage a coherent workflow by orchestrating the interactions between application server 206, database server 208 and/or file server 212, and LLM server 222. Specifically, prompt server 224 may support any prompt orchestration frameworks to simplify complex tasks or applications, including but not limited to prompt chaining, interfacing with external application programming interfaces (e.g., in application server 206), fetching contextual data from vector databases (e.g., in database server 208 or database 210) and managing memory across multiple LLM interactions (e.g., in LLM server 222).

User interface server 228 may host user interface 230 that allows users to access applications and services. User interface server 228 may include, but is not limited to, a dashboard, operation console, report console, and/or administration tab. In some aspects, user interface server 228 may display, at the dashboard, an initial design of the data pipeline created by data pipeline builder application 218. The display in user interface 230 may include, but is not limited to, specific nodes and specific connections between the nodes on a canvas, and/or configurations of those nodes. User interface server 228 may also allow users to make modifications to the initial designs of the data pipelines in user interface 230—the users can select and insert nodes representing logical operations onto a canvas of user interface 230, via “drag and drop” operations. In addition, user interface server 228 may have an interactive mode for the users to provide any user instructions to refine initial design of the data pipeline. Within the interactive mode, the user can connect and/or modify the nodes via the canvas of user interface 230 and provide other information in order to define a complete data pipeline.

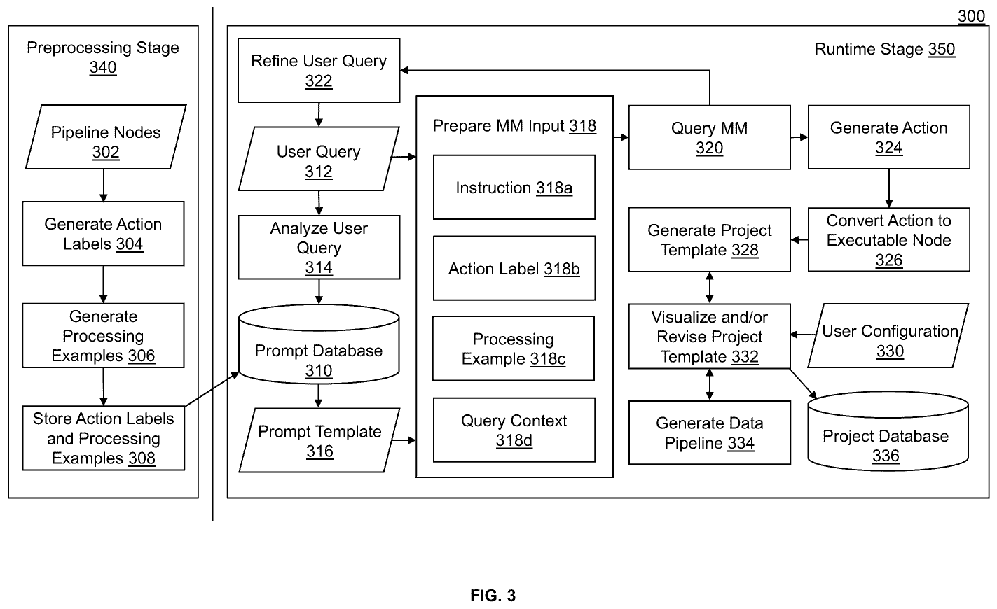

FIG. 3 is an operational framework of a data pipeline generation system 300, according to aspects of the present disclosure. Data pipeline generation system 300 may include two stages, a preprocessing stage 340 and a runtime stage 350. Runtime stage 350 can proceed independent of or without preprocessing stage 340. The runtime stage 350 can use action labels and processing examples that are added to prompt database 310 to query a multimodal model to generate any responses. In some aspects, data pipeline generation system 300 may represent data pipeline builder application 218 from system 200.

### Preprocessing Stage

In preprocessing stage 340, data pipeline generation system 200 may pre-define one or more pipeline nodes 302. A pipeline node 302 may include one or more operations to be performed using a data source. Different types of operations may be associated with different types of nodes 302 in a graphical definition of data pipeline. For example, types of operations associated with pipeline nodes 302 may include, but are not limited to, importing data, performing one or more transformations on the data, imputation of the data, analyzing the data, visualizing the data, processing the data, and/or exporting the data.

Each of these types of operations may have various options or implementations. For example, different data importation and exportation operations may be associated with different external data sources. Different data transformation operations may be associated with different data transformations, including but not limited to, different approaches to filter, select, drop, sort, group or aggregate data. Different data imputation operations may be associated with different imputation techniques, including but not limited to, different ways to fill in missing data. Different data analysis operations may be associated with different analysis techniques, including but not limited to, different statistics that can be calculated or different ways that data may be processed when calculating statistics. Different data visualization operations may also be associated with different visualizations, including but not limited to different graphs or other interfaces that may be generated. In addition, different data processing operations may be associated with data processing techniques, including but not limited to, different AI or other algorithms to perform regression, classification, and/or other operations.

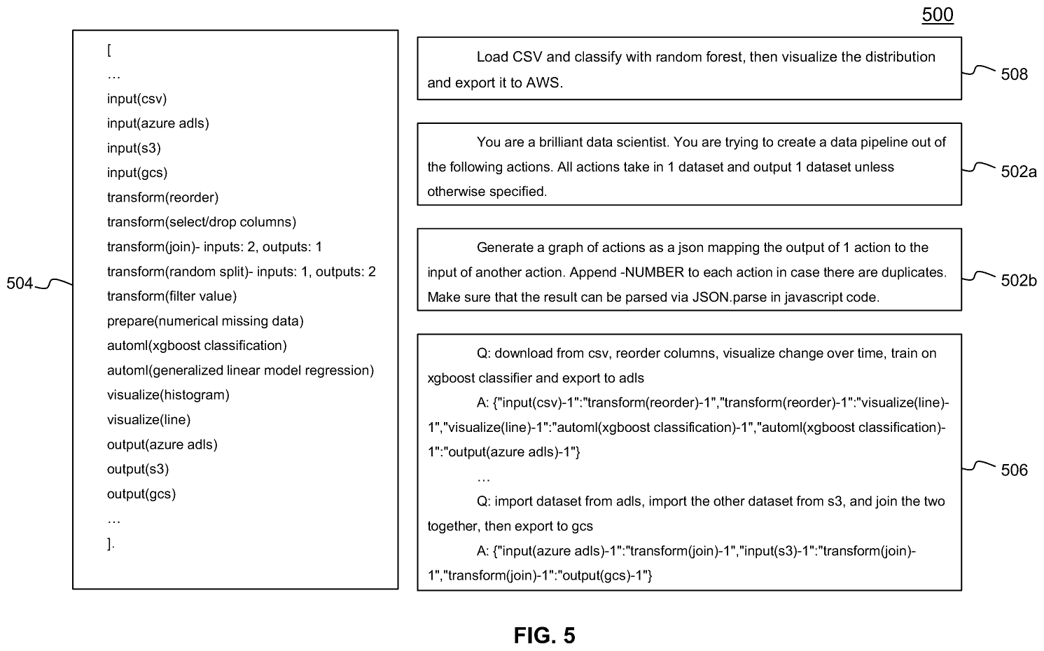

In 304, data pipeline generation system 300 may generate action labels that define the operations associated with pipeline nodes 302 and provide high-level descriptions of those operations. As a specific example, the action labels may include, but are not limited to, labels such as “input(CSV)” which defines a data importation operation for a comma separated values (CSV) data source, “transform(sort index)” which defines a data transformation operation involving a sort operation based on a particular index, and/or “automl(random forest regression)” which defines a data processing operation involving a specific type of AI or other algorithm. Some additional action labels are illustrated in FIG. 5, as list of action labels 504. In some aspects, an action label can be mapped to a specific type of pipeline node 302 that is available to data pipeline generation system 300 for implementing a data pipeline. One or more action labels may be generated or modified based on information provided by one or more users of data pipeline generation system 300.

In 306, data pipeline generation system 300 may generate processing examples with sample queries and corresponding answers, showing how a sample natural language description can be converted into corresponding data pipeline operations that the system may be able to perform (see, e.g., list of processing examples 506 in FIG. 5). The examples may include, but are not limited to, one or more natural language descriptions and an identification of which action labels would be assigned to those natural language descriptions. These examples can also provide instructions or guidance as to how the natural language descriptions may be best matched to the action labels. These examples can also show how natural language descriptions should be converted into a label graph or other MM outputs. As a specific example, the query associated with the example may be “download from csv, reorder columns, visualize change over time, train on xgboost classifier and export to adls.” The answer to this query can be {“input(csv)-1”:“transform (reorder)-1”, “transform(reorder)-1”:“visualize (line)-1”, “visualize (line)-1”: “automl(xgboost classification)-1”, “automl(xgboost classification)-1”:“output (azure adls)-1”}.

In 308, the actions labels and processing examples may be stored into a prompt database 310. In some aspects, the action labels and processing examples may be embedded. A vector index may then be used to store the embedding in which a vector index is a data structure to efficiently store and retrieve high-dimensional vector data (e.g., the action labels, processing examples, and/or their embeddings), enabling fast similarity searches and nearest neighbor queries. This vector indexing technique may involve arranging the high-dimensional vectors in a searchable and efficient manner. In addition, prompt database 310 may also be constructed to manage the vector index of the action labels or examples from 308. The functionalities of prompt database 310 may include, but are not limited to, data management, metadata storage and filtering, scalability, real-time updates, backups and collections, and/or data security and access control.

### Runtime Stage

In runtime stage 350, data pipeline generation system 200 may receive user query 312 including a natural language description or other modality description of a requested data pipeline. User query 312 may include an initial natural language request—an abstract user query input without explicitly describing the requested data pipeline. The requested data pipeline may or may not match a pre-defined data pipeline stored in prompt database 310.

In 314, data pipeline generation system 300 may analyze user query 312. In some aspects, the system may examine the user-entered keywords and/or phrases to understand the contexts and their intent. For retrieving the appropriate prompt template 316 from prompt database 310, an embedding may be calculated for user query 312. The embedding may be calculated to represent semantics of user query 312 in a multi-dimensional space, allowing for an efficient and accurate semantic and/or similarity search to be performed. The embedding approach at runtime stage 350 may be substantially similar to the embedding approach performed at preprocessing stage 340, but they can be also performed in a different manner. In some aspects, prompt template 316 retrieved from prompt database 310 may be a hard-coded template including one or more predefined action labels and processing examples. Prompt template 316 may also include, but is not limited to, one or more of the pre-defined action labels or processing examples generated and/or stored in preprocessing stage 340.

In 318, data pipeline generation system 200 may prepare a prompt to input to an MM, such as LLM 214. The MM input may include, but is not limited to an instruction 318a, one or more action labels 318b, one or more processing examples 318c, and/or a query context 318d.

FIG. 5 illustrates an example prompt 500 used to query an MM, according to aspects of the present disclosure. As an illustration, the example of FIG. 5 shows how a prompt is orchestrated to query an MM. Prompt 500 may include, but is not limited to, an instruction 502a-502b, a list of action labels 504, a list of processing examples 506, and/or a query context 508.

Instruction 502a-502b may provide a scenario or problem, and a request to complete a related task. For example, the scenario or problem may indicate “You are a brilliant data scientist. You are trying to create a data pipeline out of the following actions. All actions take in 1 dataset and output 1 dataset unless otherwise specified.” In this example, the related task indicates “Generate a graph of actions as a JSON mapping the output of 1 action to the input of another action. Append -NUMBER to each action in case there are duplicates. Make sure that the result can be parsed via JSON.parse in javascript code.” Prompt 500 may include either only a single instruction, or may include additional instructions.

A list of action labels 504 may refer to a set of operations able to be performed by data pipeline generation system 300, including but not limited to, importing data, performing one or more transformations on the data, imputation of the data, analyzing the data, visualizing the data, processing the data, and/or exporting the data.

Data pipeline generation system 300 may include a list of processing examples 506 as part of the prompt to query the MM. The -NUMBER notation may indicate a particular data source. That is, action labels associated with the same notation label, e.g., “-1”, act on the same data. If there are different groups of data being processed, different notation labels can be used to distinguish between different nodes that have the same action label, such as nodes performing the same operation at different points in the data pipeline. Also, there may not be a fixed number of processing examples that should be included in the prompt—the number of processing examples may depend on the MM capability, and/or the complexity of specific tasks. However, this may result in too much or not enough information being included in the context window of MM. Techniques including but not limited to creating summaries or combining different texts and/or examples semantically can help build a well-suited set for the processing examples—that is, by shortening a paragraph-length example to one or more sentences, the examples may become simple, and more summaries can be included.

Users may provide inputs to update list of labels 504 or processing examples 506. As a specific example, one or more users, including but not limited to, an administrator, a moderator, or any crowdsourcing users, may use an update and/or append query that may change, delete, or add some of the specification data associated with any action labels or processing examples.

Query context 508 may be a natural language description of a requested data pipeline. Query context 508 may be directly obtained from the user query, In the example of FIG. 5, query context 508 states “Load CSV and classify with random forest, then visualize the distribution and export it to AWS.” Query context 508 may be generated based on an initial natural language request from the user. For example, a user may input an initial natural language request, such as “I want to take my dataset from a local computer and transfer it to a remote file storage system.” This initial natural language request may itself be provided to an MM, such as LLM 214, to generate a more detailed natural language prompt including context for a data pipeline. For example, as an answer of this initial natural language query, the MM may answer with “import from csv, and export to gcs.” This answer to the initial natural language query may be used as query context 508 in prompt 500. In some aspects, a different prompt may be tailored more specifically to answer the initial natural language request in which query context 508 may be preprocessed to remove typographical errors, remove unnecessary words, etc.

Returning to FIG. 3, in 320, data pipeline generation system 300 may query an MM, such as LLM 214, with the prompt obtained from 318. For example, data pipeline generation system 300 may query the MM via an MM gateway and/or an MM proxy. Either the MM proxies or MM gateways can be an architectural solution that can abstract access to the MM, serving as intermediaries between data pipeline generation system 300 and the MM.

In 322, the MM may be queried to refine the user query and generate the natural language description of the requested data pipeline. In some aspects, user query 312 may be refined multiple times or not at all depending on the quality of the original or generated natural language description. Data pipeline generation system 300 may monitor the quality of the natural language description and may then incorporate any prompt chaining and tuning while querying the MM. Any suitable MMs may be queried by data pipeline generation system. For example, an MM may be “use case agnostic,” where the MM is designed to process queries across a wide range of potential topics. To help facilitate specific use cases, the prompts provided to the MM may identify the specific use cases or otherwise provide information that may help the MM tailor its responses. An MM may also be “use case specific,” where the MM is designed or fine-tuned to process queries within a limited subset of topics. Also, the MM may be able to process multi-modal user input or information, including but not limited to, text, natural language, audio, image, and/or video inputs.

In 324, the MM may be queried to generate actions corresponding to the requested data pipeline. After querying the MM at 320, data pipeline generation system 300 may receive an MM response including action labels (e.g., tokens) associated with the user's query. The MM response may identify which action labels best match the contents of the query using the prompt's lists of action labels and examples. Since the action labels are associated with different types of nodes for the platform, the MM response can be used to identify which of the platform's nodes can be used to implement the data pipeline. In some aspects, the MM response may be post-processed by, for example and without limitation, removing unnecessary words from the MM response and/or verifying whether the MM response provides valid action labels. The MM response may include a label graph that identifies selected action labels and connections between the selected action labels based on the natural language description. As a specific example, the natural language description in the query context may include, but is not limited to, “load CSV and classify with random forest, then visualize the distribution and export it to AWS.” The MM response may include, but is not limited to, {“input(CSV)-1”:“automl(random forest classification)-1”:“visualize(histogram)-1”:“output(S3)-1”}. The “-1” notation indicates that the same data (associated with a “-1” label) is processed using the four action labels. If there are different groups of data being processed, different notation labels, e.g., “-1”, “-2”, etc., can be used to distinguish between different nodes that have the same action label, such as nodes performing the same operation at different points in the data pipeline.

In 326, data pipeline generation system 300 may convert the generated actions from 324 to executable nodes. In some aspects, the executable nodes may be identified based on the action labels included in the MM response. Such identification may include, but is not limited to, parsing the MM response and/or using the tokens/action labels in the MM response (e.g., the best-matching action labels) to identify the specific types of nodes and the arrangement of nodes to be included in the data pipeline. This may also include, but is not limited to, converting a label graph as defined by the MM response into node definitions. When converting a label graph to node definitions, data pipeline generation system 300 may determine a correlation between the action labels and the one or more executable nodes. The system may then select, from an executable node library for each extracted action label, a respective one of the one or more executable nodes correlating to the extracted action label. If there is a low correlation between the extracted action label and all of the one or more executable nodes, the system may select a default executable node for the action label.

In 328, data pipeline generation system 300 may generate a project template from the one or more executable nodes obtained from 326. In some aspects, a project template may be constructed by creating a JavaScript Object Notation (JSON) file or other file representing the project template. The project template may be generated on based on combining nodes, connections, and/or configurations (e.g., as reflected in the label graph) as defined by the MM response.

In 332, data pipeline generation system 300 may visualize the project template generated from 328. This visualization may include, but is not limited to presenting an initial design of the project template in a graphical user interface such as user interface 230. The graphical user interface may also provide a preview mode to visualize, for the project template, parameters of the one or more executable nodes and the one or more connections associated with the one or more executable nodes.

In 332, data pipeline generation system 300 may also revise the project template generated from 328. In some aspects, the system may support, via the graphical user interface, an interaction between the system and the user by receiving user configuration 330 or any additional information from the user relating to the data pipeline being created. User configuration 330 may include, but is not limited to, any modifications (e.g., graphical edits) to the initial design of the data pipeline such as any desired changes in node types or connections, reordering of nodes, additions of additional nodes or connections, and/or changes or settings of node configurations.

In 334, data pipeline generation system 300 may generate the requested data pipeline from the revised project template from 332. The system may also generate the data pipeline from the initial project template generated from 328 if there are no modifications provided by the user. As this point, the system may use the project template or revised project template to create an actual data pipeline to process actual data. In addition, the project template and/or the revised project template may be exported or uploaded to project database 336. Project database 336 may also share or exchange information with prompt database 310. For example, the newly generated project template stored at project database 336 may be used to synchronize and/or update the pre-defined action labels or processing examples stored in prompt database 310 over a period of time.

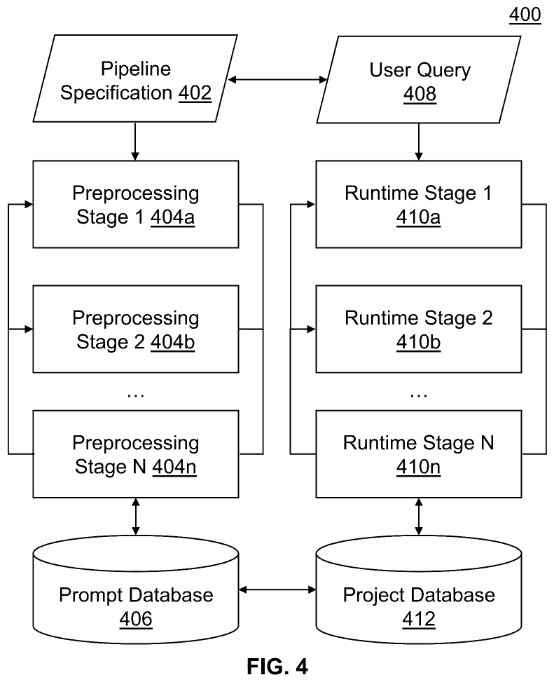

FIG. 4 is an example illustrating a workflow including multiple preprocessing stages and runtime stages of a data pipeline generation system 400, according to aspects of the present disclosure. The example of FIG. 4 shows that preprocessing stages 404a-404n may be coupled with runtime stages 410a-410n. Each preprocessing stage 404a-404n may correspond to an instance of preprocessing stage 340, while each runtime stage 410a-410n may correspond to an instane of runtime stage 350. Pipeline specification 402 may be provided to data pipeline generation system 400 at preprocessing stages 404a-404n, and user query 408 may be provided to data pipeline generation system 400 at runtime stages 410a-410n. The outputs from preprocessing stages 404a-404n may be stored or exported to prompt database 406, and the outputs from runtime stages 410a-410n may be stored or exported to project database 412.

Pipeline specification 402 may refer to a configuration file for a data pipeline. In a non-limiting example, the configuration file may be written in JavaScript Object Notation (JSON) or Yet Another Markup Language (YAML), and may include information about the pipeline's input sources, output destinations, Docker image, command, and/or other metadata. Pipeline specification 402 may also refer to conditions for retrieval information of the data pipeline, including the items for which the retrieval results will be output. Pipeline specification 402 may also include, but is not limited to, pre-defined action labels or processing examples associated with the requested data pipelines.

In preprocessing stages 404a-404n, after obtaining pipeline specification 402, data pipeline generation system 400 may transform the specification data into a usable format for subsequent analysis and processing. Data pipeline generation system 400 may be configured for subsequent execution of any tasks relating to the data pipelines being assigned. The output of preprocessing stages 404a-404n may then be stored and/or exported to a prompt database 406.

User query 408 may refer to user information that may direct data pipeline generation system 400 to generate the data pipeline. A user may express their information need via user query 408. The user may supply multi-modal information in a variety of ways, including natural language text, speech, image, video, keywords, and/or any other command languages.

In runtime stages 410a-410n, data pipeline generation system 400 may collect, process, and analyze the user query data. In some aspects, data pipeline generation system 400 may parse the user query data to identify any actions associated with the data pipeline based on the retrieving the matching action labels from prompt database 406. Data pipeline generation system 400 may also retrieve processing examples from prompt database 406 that include a natural language description of a sample data pipeline and a sample answer. Data pipeline generation system 400 may query an MM or other AI models to generate the data pipeline (e.g., by generating and implementing a project template). The output of runtime stages 410a-410n may then be stored and/or exported to a project database 412.

Pipeline specification 402 may share or exchange information with user query 408. For example, elements of pipeline specification 402 may be used in user query 408. Prompt database 406 may also share or exchange information with project database 412. For example, the newly generated project template may be used to update the pre-defined action labels or processing examples over a period of time.

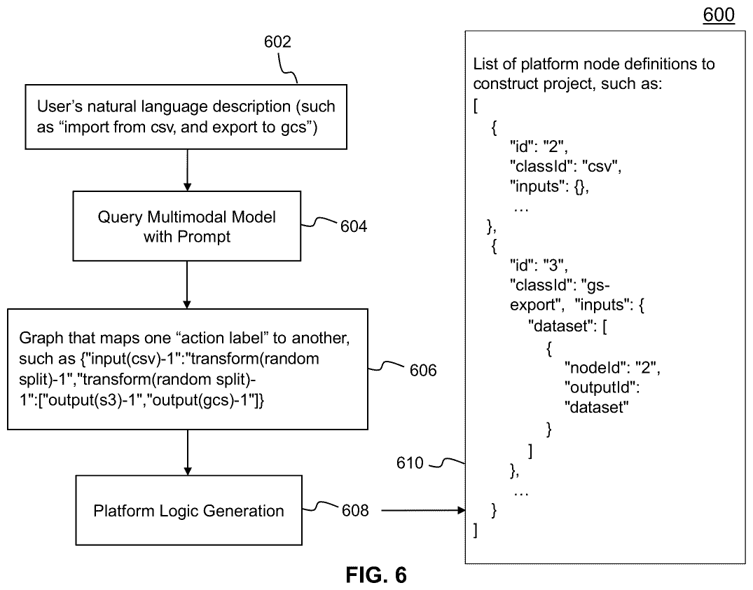

FIG. 6 is an example illustrating process flow 600 associated with project template generation performed by a data pipeline generation system 200, according to aspects of the present disclosure. As an illustration, the example of FIG. 6 shows how a project template is generated by the system. A natural language description 602 may be obtained from the user, such as “import from csv, and export to gcs.” In 604, natural language description 602 may be combined with a prompt template (e.g., the prompt template described above) and sent to an MM during a query operation. The prompt template may be affixed as a prefix to natural language description 602, although any other suitable combinations of the prompt template and natural language description 602 may also be used. The MM may process natural language description 602 along with the prompt template, and then generate an MM response 606. MM response 606 may be a graph that maps selected action labels from the prompt template with each other to create a dataflow among the selected action labels. In the example of FIG. 6, response 606 includes “{“input(csv)-1”: “transform(random split)-1”, “transform(random split)-1”:[“output(s3)-1”, “output (gcs)-1”]}”. The “-1” notation may indicate that the same data is processed using the input, transform, and output action labels. In 608, a platform logic generation function can be used to identify the specific action labels included in MM response 606 and, based on the identified action labels and/or data flows, automatically create code 610 (e.g., a list of platform node definitions) defining at least part of a project template. Code 610 may represent a JSON file or any other files supported by data pipeline generation system 200.

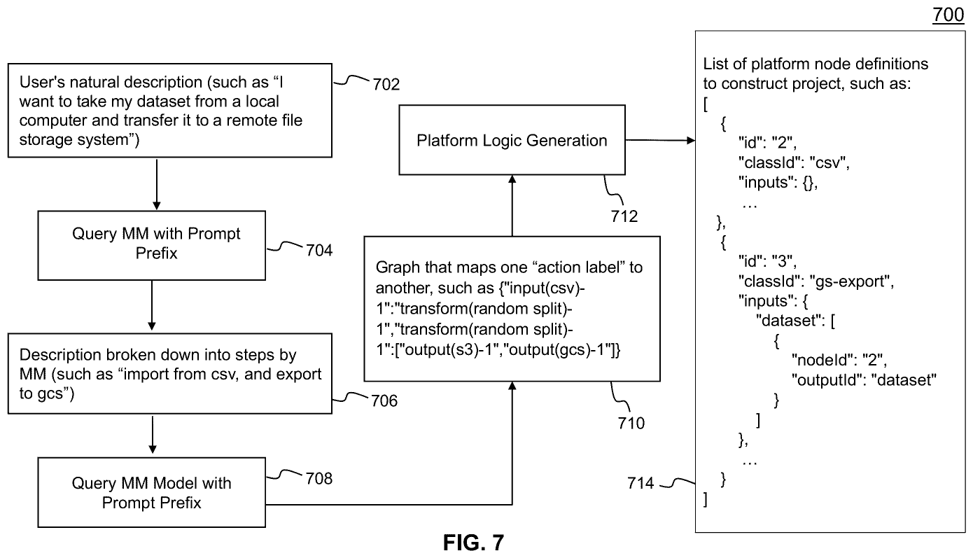

FIG. 7 is another example illustrating process flow 700 associated with project template generation performed by a data pipeline generation system 200, according to aspects of the present disclosure. As an illustration, the example of FIG. 7 shows how a project template is generated by the system. In some aspects, multiple queries may be sent to query the MM or different MMs, and multiple MM responses (e.g., from the same or different MMs) may be received and processed. This can allow for various levels of abstraction in the interactions with the MMs. For example, in 702 the user may initially provide a higher-level natural language description (e.g., initial natural language request) of what the user wishes to accomplish using a data pipeline to be created, such as ““I want to take my dataset from a local computer and transfer it to a remote file storage system.” In 704, the higher-level natural language description may be provided to an MM during a query operation, along with a suitable prompt—such as one that may be tailored to answer this specific type of query. The MM can return an initial MM response 706—a description that can be broken down into steps that can be more easily converted to the action labels and/or tokens, such as “import from csv, and export to gcs.” In 708, MM response 706 can be provided to the MM as a natural language description of a data pipeline. In 708, MM response 706 (e.g., the natural language description) may be combined with a prompt template and then sent to the MM during another query operation. The prompt template may be affixed as a prefix to MM response 706, although any other suitable combinations of the prompt template and MM response 706 may also be used. The MM may process MM response 706 along with the prompt template and then generate another MM response 710. MM response 710 can map selected action labels from the prompt template with one another to create a dataflow among the selected action labels, such as “{“input(csv)-1”:“transform (random split)-1”, “transform(random split)-1”:[“output(s3)-1”, “output(gcs)-1”]}”. In 712, a platform logic generation function can be used to identify the specific action labels included in MM response 710 and, based on the identified action labels and/or data flows, to automatically create code 714, in a JSON file or any other files, defining at least part of a project template. In some aspects, the suitable prompt used in 704 may include the same prompt used in 708 but the prompt may also be different.

### Graphical User Interface

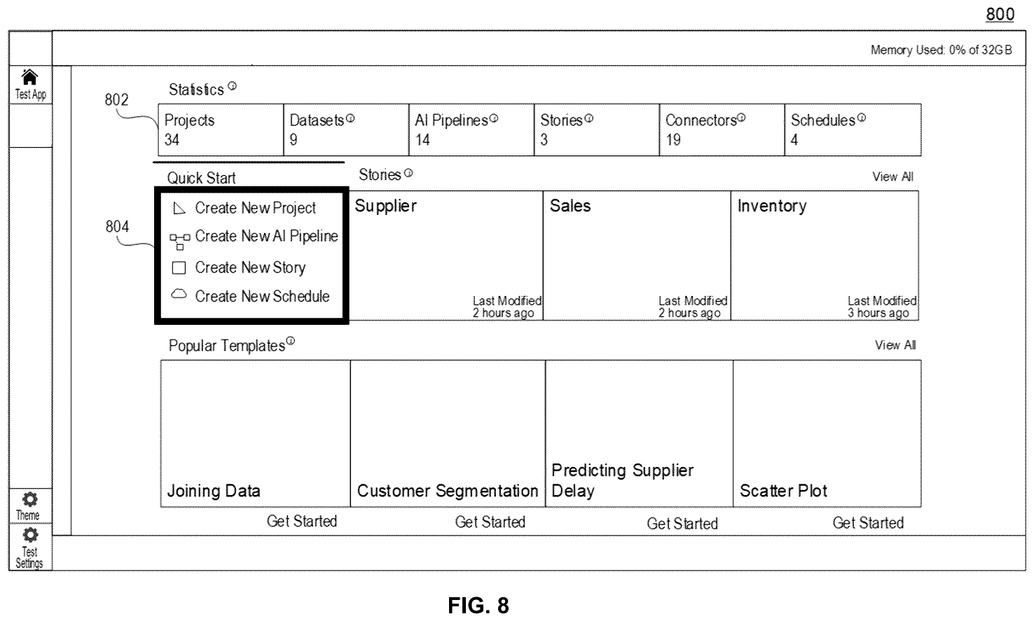

FIG. 8 is an example illustrating a graphical user interface 800 associated with project template generation performed by a data pipeline generation system 200, according to aspects of the present disclosure. As an illustration, graphical user interface 800 may provide a user with various options related to projects associated with the user. For example, an overview section 802 may provide various information about the user's existing projects, including but not limited to, a number of projects, a number of datasets involved in those projects, a number of pipelines involved in those projects, and/or other metadata information.

The graphical user interface 800 may also include a control section 804 for invoking certain functions, including but not limited to, creation of a new project, creation of a new AI pipeline, and/or creation of any other project-related functions.

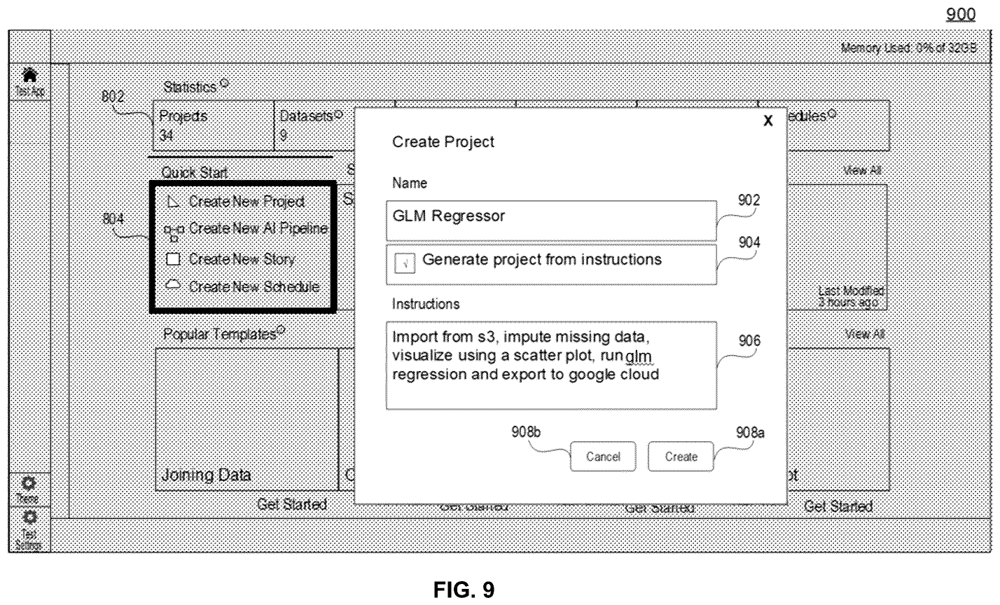

FIG. 9 is an example illustrating a graphical user interface 900 associated with project template generation performed by a data pipeline generation system 200, according to aspects of the present disclosure. Graphical user interface 900 may be presented following a selection in control section 804 on graphical user interface 800 to create a new project. As an illustration, graphical user interface 900 may provide the user with a text field 902 to enter a name for the new project. Graphical user interface 900 may provide a control selector 904 to select whether the project will be automatically created. Graphical user interface 900 may also provide the user with a text field 906 that may allow the user to enter a natural language description of the new project. In addition, graphical user interface 900 may provide control selectors 908a-908b to confirm creation (908a) of the new project or cancellation (908b) of the new project.

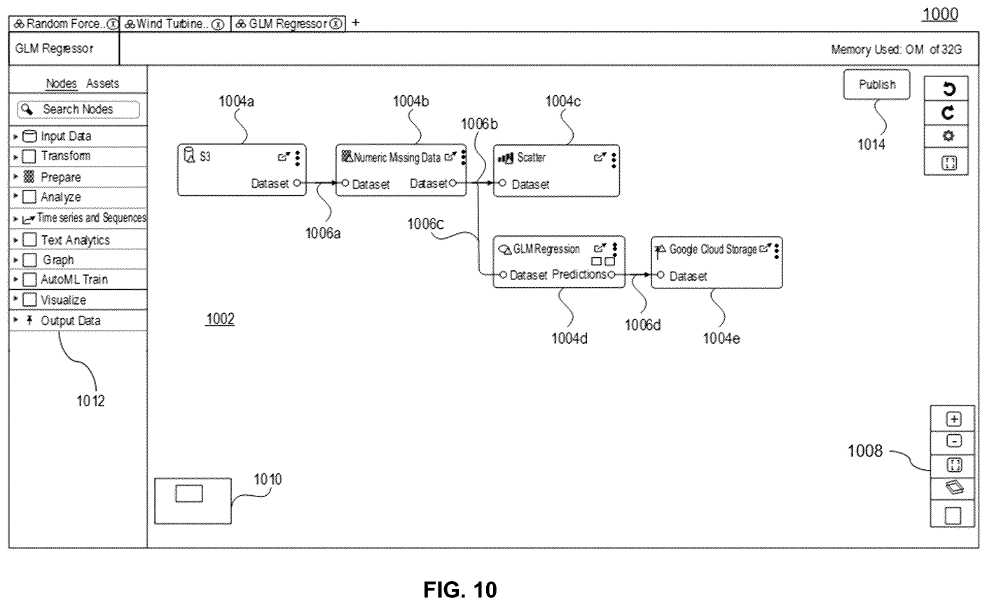

FIG. 10 is an example illustrating a graphical user interface 1000 associated with project template generation performed by a data pipeline generation system 200, according to aspects of the present disclosure. Graphical user interface 1000 may be presented following a confirmation on graphical user interface 900 to create a new project in accordance with the natural language description entered by the user. As an illustration, graphical user interface 1000 may provide the user with a canvas 1002 that allows the user to graphically identify various nodes 1004a-1004e and connections 1006a-1006d as determined using the MM. The nodes 1004a-1004e and connections 1006a-1006d may have been automatically identified based on the natural language description of the new project.

Graphical user interface 1000 may allow the user to customize operations at each node 1004a-1004e, including but not limited to, adding, deleting, and/or moving any of nodes 1004a-1004e. Graphical user interface 1000 may also allow the user to customize operations at each connection 1006a-1006d, including but not limited to, adding, deleting, and/or moving any of connections 1006a-1006d. In addition, graphical user interface 1000 may allow the user to perform other project-related functions relating to any of nodes 1004a-1004e and/or their connections 1006a-1006d.

Graphical user interface 1000 may provide the user with a view control section 1008 that invokes different user viewing perspectives, including but not limited to those for zoom-in and zoom-out capabilities. Graphical user interface 1000 may also provide a navigation control section 1010 that allows the user to navigate within a larger canvas 1002 or to see where the current view of canvas 1002 falls within the entire canvas 1002.

Graphical user interface 1000 may provide the user with an editing control section 1012 that allows the user to select and insert additional nodes and/or connections onto canvas 1002. In some aspects, graphical user interface 1000 may also provide an export control section 1014 that can be used to automatically export and/or publish a project template (e.g., as defined using the nodes 1004a-1004e and connection 1006a-1006d) for the new project to be created by the system.

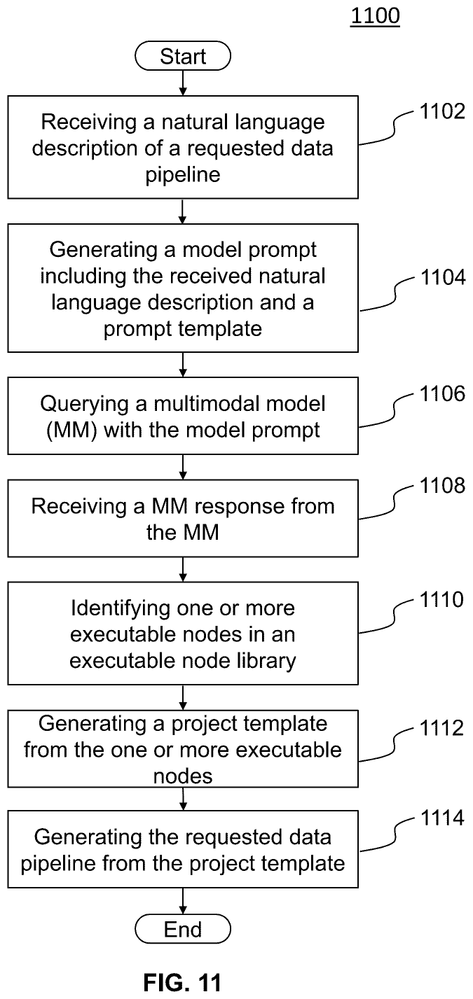

FIG. 11 is a flowchart illustrating a method for generating a data pipeline, according to aspects of the present disclosure. Method 1100 may be performed by processing logic that may comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 11, as will be understood by a person of ordinary skill in the art. Method 1100 shall be described with reference to at least FIGS. 2, 3, 6, and 7. However, method 1100 is not limited to that those example aspects.

In 1102, a natural language description of a requested data pipeline may be received. In some aspects, prior to receiving the natural language description, an initial natural language request may be received from a user, and an MM may be queried with the initial natural language request to generate the natural language description of the request data pipeline. The natural language description may be received by data pipeline builder application 218 via user interface 230.

In 1104, a model prompt including the received natural language description and a prompt template may be generated. The model prompt may be generated by data pipeline builder application 218 in conjunction with at least one of prompt server 224, database server 208, and/or file server 212. The prompt template may include a set of action labels and at least one processing example. Each action label in the set of action labels may indicate a respective data processing action. The processing example may include a sample query including a sample natural language description of a sample data pipeline and a sample answer including one or more sample action labels associated with the sample natural language description. Each of the one or more sample action labels may be included in the set of action labels, in which the set of action labels may be generated on-the-fly based on a listing of available executable nodes in the executable node library.

In some aspects, at least one of the set of action labels, one or more processing examples, and/or the one or more executable nodes may be pre-defined in a database. The database may be, for example, database 210. The database may be updated by adding, to the database, at least one of a new action label, a new processing example, and/or a new executable node. The database may also be updated by deleting, from the database, at least one of the one or more action labels, the one or more processing examples, and/or the one or more executable nodes.

In some aspects, the sample answer of the prompt template may further include, for each of the one or more action labels associated with the sample natural language description, a data source label identifying a data source on which the data processing action of the action label will operate. The MM response may further include one or more data source labels in which each data source label may be associated with a respective one of the one or more action labels in the MM response. Two or more action labels in the MM response may be associated with identical data source labels. The prompt template may also include additional processing examples in which each additional processing example may include an additional sample query and an additional sample answer.

In 1106, an MM may queried with the model prompt. In some aspects, an MM and/or different MMs may be queried multiple times with the model prompt and/or any other model prompts tailored for a specific querying operation. The MM may be, for example, LLM 214.

In 1108, an MM response may be received from the MM. The MM response may include one or more action labels corresponding to the natural language description of the requested data pipeline in a format guided by the prompt template. The MM response may be received by, for example, data pipeline builder application 218.

In 1110, one or more executable nodes in an executable node library may be identified in which each executable node may correspond to a respective action label in the MM response and may also be configured to perform the data processing action associated with the respective action label. The executable node library may be stored in, for example database 210, and identified by, for example, data pipeline builder application 218.

In some aspects, the identifying may include, but is not limited to, parsing the MM response to extract the one or more action labels, determining, for each extracted action label, a correlation between the extracted action label and the one or more executable nodes, and selecting, from the executable node library for each extracted action label, a respective one of the one or more executable nodes correlating to the extracted action label or a default executable node based on the correlation between the extracted action label and the one or more executable nodes being low. In some aspects, at least two types of data processing actions of the data pipeline may be collectively identified by the one or more executable nodes.

In 1112, a project template from the one or more executable nodes may be generated in which the project template may include the one or more executable nodes and one or more connections associated with the one or more executable nodes. The project template may be generated by, for example, data pipeline builder application, and stored as, for example project template 220. Each of the one or more executable nodes may be associated with one or more parameters. The parameters may include, for example, parameters to be configured by a user or specified by the system for a particular use case.

In 1114, the request data pipeline may be generated from the project template. The requested data pipeline may be generated by, for example, data pipeline builder application 218.

In some aspects, a user interface may be generated to visualize the project template. The user interface may be, for example, user interface 230. The user interface may provide a preview mode including the project template. The preview mode may visualize the one or more executable nodes and the one or more connections associated with the one or more executable nodes. In some aspects, the project template may be updated using the user interface based on additional information received from the user. The additional information may include one or more edits associated with at least one parameter of the one or more executable nodes and/or the one or more connections associated with the one or more executable nodes.

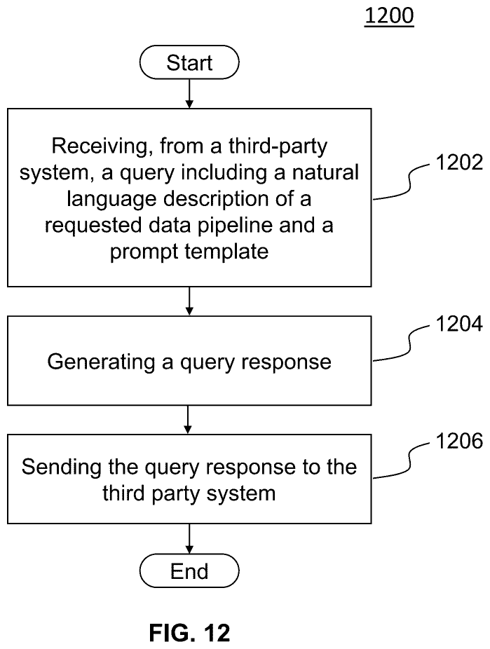

FIG. 12 is a flowchart illustrating a method for generating, by an MM, a project template including one or more action labels and one or more data source labels associated with the one or more action labels, according to aspects of the present disclosure. Method 1200 may be performed by processing logic that may comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 12, as will be understood by a person of ordinary skill in the art. Method 1200 shall be described with reference to at least FIGS. 2, 3, 5, 6, and 7. However, method 1200 is not limited to those example aspects.

In 1202, a query including a natural language description of a requested data pipeline and a prompt template may be received at an MM from a third-party system. The MM may be, for example, LLM 214. The prompt template may include a set of action labels and at least one processing example. Each action label in the set of action labels may indicate a respective data processing action. A processing example may include a sample query including a sample natural language description of a sample data pipeline and a sample answer including one or more sample action labels associated with the sample natural language description. Each of the one or more sample action labels may be included in the set of action labels.

In some aspects, prior to the receiving, an initial query including an initial natural language description of the requested data pipeline may be received by the MM from the third-party system. An initial query response including the natural language description of the requested data pipeline may be generated by the MM, and/or the natural language description of the requested data pipeline may be sent to the third-party system. The initial query response may include at least one of a spelling error correction, a typographical error correction, and/or a more detailed expression of the initial natural language description.

In 1204, a query response including one or more action labels corresponding to the natural language description of the requested data pipeline in a format guided by the prompt template may be generated by the MM. The generating the query response may include, but is not limited to, generating one or more data source labels in which each data source label may be associated with a respective action label and/or identifying a data source on which the data processing action of the respective action label will operate. Also, two or more action labels in the MM may be associated with identical data source labels.

In 1206, the query response may be sent to the third-party system by the MM. Sending the query response may involve, for example, using a dedicated API endpoint provided by the third-party system, such that the query response may be sent in a structured format according to the specifications of the third-party system's API, such as JSON, YAML, XML, or any other supported files. In some aspects, the query response may be used by the third-party system as described above with respect to steps 1110-1114 of FIG. 11.

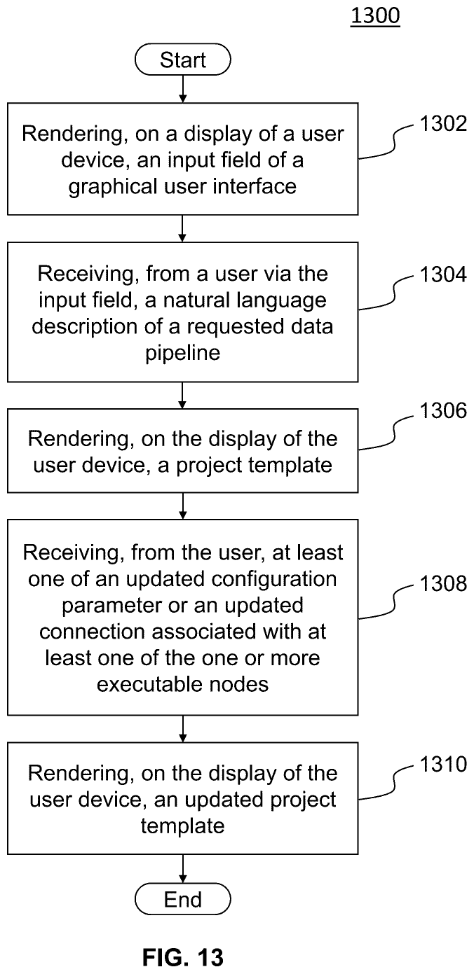

FIG. 13 is a flowchart illustrating a method for rendering a graphical user interface, according to aspects of the present disclosure. Method 1300 may be performed by processing logic that may comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 13, as will be understood by a person of ordinary skill in the art. Method 1300 shall be described with reference to at least FIG. 2, 3, 8-10. However, method 1300 is not limited to that those example aspects.

In 1302, an input filed of a graphical user interface may be rendered on a display of a user device. The graphical user interface may be, for example, user interface 230, rendered on a display of, for example, a user device 202a-d.

In 1304, a natural language description of a requested data pipeline may be received from a user via an input field of the graphical user interface.

In 1306, a project template including one or more executable nodes in the requested data pipeline may be rendered on the display of the user device via the graphical user interface. The graphical user interface may display a project template received from, for example, data pipeline builder application 218. Each of the one or more executable nodes in the requested data pipeline may be identified from an MM response including a set of action labels indicating a respective executable node's data processing action. The project template may include the one or more executable nodes and one or more connections associated with the one or more executable nodes. In some aspects, the project template may be rendered in an object-based interactive area of the display of the user device.

In 1308, at least one of an updated parameter or an updated connection associated with at least one of the one or more executable nodes may be received from the user via the graphical user interface.

In 1310, an updated project template including the one or more executable nodes in the requested data pipeline may be rendered on the display of the user device via the graphical user interface based on the at least one updated parameter or updated connection.

In addition, a visualization of data being processed through the requested data pipeline via the project template may be rendered on the display of the user device via the graphical user interface based on the one or more executable nodes and the one or more connections.

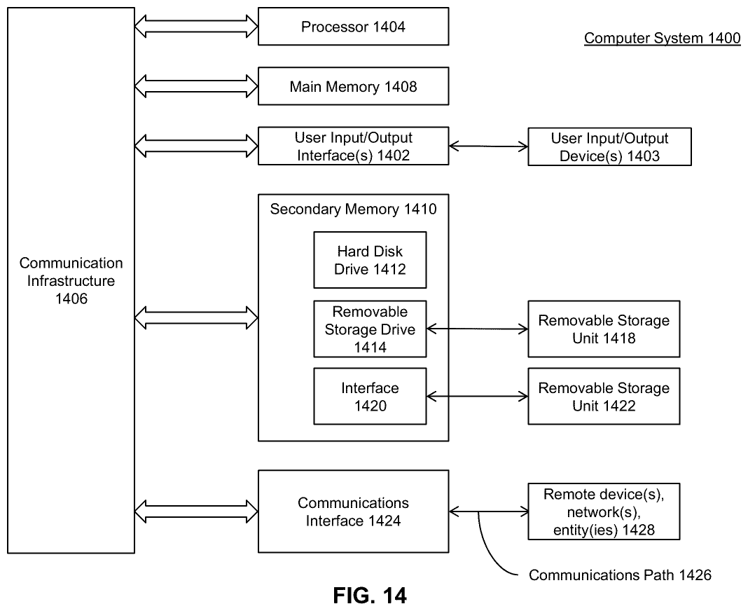

Various aspects may be implemented, for example, using one or more well-known computer systems, such as computer system 1400 shown in FIG. 14. For example, aspects herein using the metadata retrieval system may be implemented using combinations or sub-combinations of computer system 1400. Also or alternatively, one or more computer systems 1400 may be used, for example, to implement any of the aspects discussed herein, as well as combinations and sub-combinations thereof. A “module,” as the term is used herein, is a computational element that performs one or more functions according to computer readable instructions stored on one or more memories or other non-transitory computer-readable media.

Computer system 1400 may include one or more processors (also called central processing units, or CPUs), such as a processor 1404. Processor 1404 may be connected to a communication infrastructure or bus 1406.

Computer system 1400 may also include user input/output device(s) 1403, such as monitors, keyboards, pointing devices, etc., which may communicate with communication infrastructure 1406 through user input/output interface(s) 1402.

One or more of processors 1404 may be a graphics processing unit (GPU). In an aspect, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1400 may also include a main or primary memory 1408, such as random access memory (RAM). Main memory 1408 may include one or more levels of cache. Main memory 1408 may have stored therein control logic (i.e., computer software) and/or data.

Computer system 1400 may also include one or more secondary storage devices or memory 1410. Secondary memory 1410 may include, for example, a hard disk drive 1412 and/or a removable storage device or drive 1414. Removable storage drive 1414 may be a floppy disk drive, a magnetic tape drive, a compact disk drive, an optical storage device, tape backup device, and/or any other storage device/drive.

Removable storage drive 1414 may interact with a removable storage unit 1418. Removable storage unit 1418 may include a computer usable or readable storage device having stored thereon computer software (control logic) and/or data. Removable storage unit 1418 may be a floppy disk, magnetic tape, compact disk, DVD, optical storage disk, and/any other computer data storage device. Removable storage drive 1414 may read from and/or write to removable storage unit 1418.

Secondary memory 1410 may include other means, devices, components, instrumentalities or other approaches for allowing computer programs and/or other instructions and/or data to be accessed by computer system 1400. Such means, devices, components, instrumentalities or other approaches may include, for example, a removable storage unit 1422 and an interface 1420. Examples of the removable storage unit 1422 and the interface 1420 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 1400 may further include a communication or network interface 1424. Communication interface 1424 may enable computer system 1400 to communicate and interact with any combination of external devices, external networks, external entities, etc. (individually and collectively referenced by reference number 1428). For example, communication interface 1424 may allow computer system 1400 to communicate with external or remote devices 1428 over communications path 1426, which may be wired and/or wireless (or a combination thereof), and which may include any combination of LANs, WANs, the Internet, etc. Control logic and/or data may be transmitted to and from computer system 1400 via communication path 1426.

Computer system 1400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some aspects, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1400, main memory 1408, secondary memory 1410, and removable storage units 1418 and 1422, as well as tangible articles of manufacture embodying any combination of the foregoing. Such control logic, when executed by one or more data processing devices (such as computer system 1400 or processor(s) 1404), may cause such data processing devices to operate as described herein.

Based on the teachings included in this disclosure, it will be apparent to persons skilled in the relevant art(s) how to make and use aspects of this disclosure using data processing devices, computer systems and/or computer architectures other than that shown in FIG. 14. In particular, aspects can operate with software, hardware, and/or operating system implementations other than those described herein.

### Example Aspects

The following examples are illustrative only and do not limit the scope of the present disclosure or the appended claims.

Example 1: A computer-implemented method performed by one or more computing devices comprises receiving a natural language description of a requested data pipeline and generating a model prompt comprising the received natural language description and a prompt template. The prompt template comprises a set of action labels and a processing example, each action label in the set of action labels indicates a respective data processing action, and the processing example includes a sample query comprising a sample natural language description of a sample data pipeline and a sample answer comprising one or more sample action labels associated with the sample natural language description of the sample data pipeline, each of the one or more sample action labels being included in the set of action labels. The example method further comprises querying a multimodal model (MM) with the model prompt and receiving an MM response from the MM, wherein the MM response comprises one or more action labels corresponding to the natural language description of the requested data pipeline in a format guided by the prompt template. One or more executable nodes in an executable node library are identified, each executable node corresponding to a respective action label in the MM response and configured to perform the data processing action associated with the respective action label. The example method further comprises generating a project template from the one or more executable nodes, wherein the project template comprises the one or more executable nodes and one or more connections associated with the one or more executable nodes. The requested data pipeline is then generated from the project template.

Example 2: The computer-implemented method of example 1, wherein the sample answer of the prompt template further comprises, for each of the one or more action labels associated with the sample natural language description, a data source label identifying a data source on which the data processing action of the action label will operate, and the MM response further comprises one or more data source labels, each data source label associated with a respective one of the one or more action labels in the MM response.

Example 3: The computer-implemented method of example 2, wherein two or more action labels in the MM response are associated with identical data source labels.

Example 4: The computer-implemented method of any of examples 1-3, wherein the prompt template comprises additional processing examples, each additional processing example including an additional sample query and an additional sample answer.

Example 5: The computer-implemented method of any of examples 1-4, further comprises, prior to receiving the natural language description, receiving, from a user, an initial natural language request, and querying the MM with the initial natural language request to generate the natural language description of the requested data pipeline.

Example 6: The computer-implemented method of any of examples 1-5, further comprises generating the set of action labels on-the-fly based on a listing of available executable nodes in the executable node library.

Example 7: The computer-implemented method of any of examples 1-6, further comprises generating a user interface to visualize the project template. The user interface provides a preview mode comprising the project template, wherein the preview mode visualizes the one or more executable nodes and the one or more connections associated with the one or more executable nodes.

Example 8: The computer-implemented method of any of examples 1-7, further comprises updating, using a user interface, the project template based on additional information received from the user. The additional information comprises one or more edits associated with at least one parameter of the one or more executable nodes or the one or more connections associated with the one or more executable nodes.

Example 9: The computer-implemented method of any of examples 1-8, wherein at least one of the set of action labels, one or more processing examples, or the one or more executable nodes are pre-defined in a database.

Example 10: The computer-implemented method of example 9, further comprises updating the database by adding, to the database, at least one of a new action label, a new processing example, or a new executable node.

Example 11: The computer-implemented method of any of examples 9-10, further comprises updating the database by deleting, from the database, at least one of the one or more action labels, the one or more processing examples, or the one or more executable nodes.

Example 12: The computer-implemented method of any of examples 1-11, wherein the identifying comprises parsing the MM response to extract the one or more action labels, determining, for each extracted action label, a correlation between the extracted action label and the one or more executable nodes; and selecting, from the executable node library for each extracted action label, a respective one of the one or more executable nodes correlating to the extracted action label or a default executable node based on the correlation between the extracted action label and the one or more executable nodes being low.

Example 13: The computer-implemented method of any of examples 1-12, wherein the one or more executable nodes collectively identify at least two types of data processing actions of the data pipeline.

Example 14: A computer-implemented method performed by one or more computing devices, comprises receiving, by a multimodal model (MM) from a third party system, a query comprising a natural language description of a requested data pipeline and a prompt template. The prompt template comprises a set of action labels and a processing example, each action label in the set of action labels indicates a respective data processing action, and the processing example includes a sample query comprising a sample natural language description of a sample data pipeline and a sample answer comprising one or more sample action labels associated with the sample natural language description of the sample data pipeline, each of the one or more sample action labels being included in the set of action labels. The example method further comprises generating, by the MM, a query response comprising one or more action labels corresponding to the natural language description of the requested data pipeline in a format guided by the prompt template, and sending the query response to the third party system.

Example 15: The computer-implemented method of example 14, wherein the generating the query response further comprises generating one or more data source labels, each data source label associated with a respective action label and identifying a data source on which the data processing action of the respective action label will operate.

Example 16: The computer-implemented method of example 15, wherein two or more action labels in the MM response are associated with identical data source labels.

Example 17: The computer-implemented method of any of examples 14-16, wherein the prompt template received by the MM comprises additional processing examples, each additional processing example including an additional sample query and an additional sample answer.

Example 18: The computer-implemented method of any of examples 14-17, further comprises, prior to the receiving, receiving, by the MM from the third party system, an initial query comprising an initial natural language description of the requested data pipeline, generating, by the MM, an initial query response comprising the natural language description of the requested data pipeline, and sending the natural language description of the requested data pipeline to the third party system.

Example 19: The computer-implemented method of example 18, wherein the initial query response comprises at least one of a spelling error correction, a typographical error correction, or a more detailed expression of the initial natural language description.

Example 20: A computer-implemented method performed by one or more computing devices, comprises rendering, on a display of a user device, an input field of a graphical user interface, receiving, from a user via the input field, a natural language description of a requested data pipeline, and rendering, on the display of the user device, a project template comprising one or more executable nodes in the requested data pipeline, each of the one or more executable nodes identified from a multimodal model (MM) response comprising corresponding action labels indicating a respective executable node's data processing action. The project template comprises the one or more executable nodes and one or more connections associated with the one or more executable nodes.

Example 21: The computer-implemented method of example 20, further comprises receiving, from the user, at least one of an updated parameter or an updated connection associated with at least one of the one or more executable nodes, and rendering, on the display of the user device, an updated project template comprising the one or more executable nodes in the requested data pipeline based on the at least one updated parameter or updated connection.

Example 22: The computer-implemented method of any of examples 20-21, wherein rendering the project template comprises rendering the project template in an object-based interactive area of the display of the user device.

Example 23: The computer-implemented method of any of examples 20-22, further comprises rendering, on the display of the user device, a visualization of data being processed through the requested data pipeline via the project template based on the one or more executable nodes and the one or more connections.

Example 24: A system comprises one or more processors and a memory having instructions stored thereon that, when executed by the one or more processors, cause the one or more processors to perform operations comprising, receiving a natural language description of a requested data pipeline and generating a model prompt comprising the received natural language description and a prompt template. The prompt template comprises a set of action labels and a processing example, each action label in the set of action labels indicates a respective data processing action, and the processing example includes a sample query comprising a sample natural language description of a sample data pipeline and a sample answer comprising one or more sample action labels associated with the sample natural language description of the sample data pipeline, each of the one or more sample action labels being included in the set of action labels. The operations further comprise querying a multimodal model (MM) with the model prompt, receiving an MM response from the MM, wherein the MM response comprises one or more action labels corresponding to the natural language description of the requested data pipeline in a format guided by the prompt template. One or more executable nodes in an executable node library are identified, each executable node corresponding to a respective action label in the MM response and configured to perform the data processing action associated with the respective action label. The operations further comprise generating a project template from the one or more executable nodes, wherein the project template comprises the one or more executable nodes and one or more connections associated with the one or more executable nodes. The requested data pipeline is then generated from the project template.

Example 25: The system of claim 24, wherein the sample answer of the prompt template further comprises, for each of the one or more action labels associated with the sample natural language description, a data source label identifying a data source on which the data processing action of the action label will operate, and the MM response further comprises one or more data source labels, each data source label associated with a respective one of the one or more action labels in the MM response.

Example 26: The system of claim 25, wherein two or more action labels in the MM response are associated with identical data source labels.

Example 27: The system of any of claims 24-26, wherein the prompt template comprises additional processing examples, each additional processing example including an additional sample query and an additional sample answer.

Example 28: The system of any of claims 24-27, wherein the operations further comprise, prior to receiving the natural language description, receiving, from a user, an initial natural language request; and querying the MM with the initial natural language request to generate the natural language description of the requested data pipeline.

Example 29: The system of any of examples 24-28, wherein the operations further comprise generating the set of action labels on-the-fly based on a listing of available executable nodes in the executable node library.

Example 30: The system of any of examples 24-29, wherein the operations further comprise generating a user interface to visualize the project template. The user interface provides a preview mode comprising the project template, wherein the preview mode visualizes the one or more executable nodes and the one or more connections associated with the one or more executable nodes.

Example 31: The system of any of examples 24-30, wherein the operations further comprise updating, using a user interface, the project template based on additional information received from the user. The additional information comprises one or more edits associated with at least one parameter of the one or more executable nodes or the one or more connections associated with the one or more executable nodes.

Example 32: The system of any of examples 24-31, wherein at least one of the set of action labels, one or more processing examples, or the one or more executable nodes are pre-defined in a database.

Example 33: The system of example 32, wherein the operations further comprise updating the database by adding, to the database, at least one of a new action label, a new processing example, or a new executable node.

Example 34: The system of any of examples 32-33, wherein the operations further comprise updating the database by deleting, from the database, at least one of the one or more action labels, the one or more processing examples, or the one or more executable nodes.

Example 35: The system of any of examples 24-34, wherein the identifying operation comprises parsing the MM response to extract the one or more action labels, determining, for each extracted action label, a correlation between the extracted action label and the one or more executable nodes, and selecting, from the executable node library for each extracted action label, a respective one of the one or more executable nodes correlating to the extracted action label or a default executable node based on the correlation between the extracted action label and the one or more executable nodes being low.

Example 36: The system of any of examples 24-35, wherein the one or more executable nodes collectively identify at least two types of data processing actions of the data pipeline.

Example 37: A system, comprises one or more processors, and a memory having instructions stored thereon that, when executed by the one or more processors, cause the one or more processors to perform operations comprising receiving, by a multimodal model (MM) from a third party system, a query comprising a natural language description of a requested data pipeline and a prompt template. The prompt template comprises a set of action labels and a processing example, each action label in the set of action labels indicates a respective data processing action, and the processing example includes a sample query comprising a sample natural language description of a sample data pipeline and a sample answer comprising one or more sample action labels associated with the sample natural language description of the sample data pipeline, each of the one or more sample action labels being included in the set of action labels. The operations further comprise generating, by the MM, a query response comprising one or more action labels corresponding to the natural language description of the requested data pipeline in a format guided by the prompt template. The query response is then sent to the third party system.

Example 38: The system of example 37, wherein the generating the query response operation further comprises generating one or more data source labels, each data source label associated with a respective action label and identifying a data source on which the data processing action of the respective action label will operate.

Example 39: The system of example 38, wherein two or more action labels in the MM response are associated with identical data source labels.

Example 40: The system of any of examples 37-39, wherein the prompt template received by the MM comprises additional processing examples, each additional processing example including an additional sample query and an additional sample answer.

Example 41: The system of any of examples 37-40, wherein the operations further comprise, prior to the receiving operation, receiving, by the MM from the third party system, an initial query comprising an initial natural language description of the requested data pipeline, generating, by the MM, an initial query response comprising the natural language description of the requested data pipeline; and sending the natural language description of the requested data pipeline to the third party system.

Example 42: The system of example 41, wherein the initial query response comprises at least one of a spelling error correction, a typographical error correction, or a more detailed expression of the initial natural language description.

Example 43: A system, comprises one or more processors, and a memory having instructions stored thereon that, when executed by the one or more processors, cause the one or more processors to perform operations comprising rendering, on a display of a user device, an input field of a graphical user interface, receiving, from a user via the input field, a natural language description of a requested data pipeline, and rendering, on the display of the user device, a project template comprising one or more executable nodes in the requested data pipeline, each of the one or more executable nodes identified from a multimodal model (MM) response comprising corresponding action labels indicating a respective executable node's data processing action, wherein the project template comprises the one or more executable nodes and one or more connections associated with the one or more executable nodes.

Example 44: The system of example 43, wherein the operations further comprise receiving, from the user, at least one of an updated parameter or an updated connection associated with at least one of the one or more executable nodes, and rendering, on the display of the user device, an updated project template comprising the one or more executable nodes in the requested data pipeline based on the at least one updated parameter or updated connection.

Example 45: The system of any of examples 43-44, wherein the rendering the project template operation comprises rendering the project template in an object-based interactive area of the display of the user device.

Example 46: The system of any of examples 43-45, wherein the operations further comprise rendering, on the display of the user device, a visualization of data being processed through the requested data pipeline via the project template based on the one or more executable nodes and the one or more connections.

Example 47: A non-transitory computer-readable storage medium having instructions stored thereon that, when executed by one or more processing devices, cause the one or more processing devices to perform operations comprising receiving a natural language description of a requested data pipeline, generating a model prompt comprising the received natural language description and a prompt template. The prompt template comprises a set of action labels and a processing example, each action label in the set of action labels indicates a respective data processing action, and the processing example includes a sample query comprising a sample natural language description of a sample data pipeline and a sample answer comprising one or more sample action labels associated with the sample natural language description of the sample data pipeline, each of the one or more sample action labels being included in the set of action labels. The operations further comprise querying a multimodal model (MM) with the model prompt and receiving an MM response from the MM, wherein the MM response comprises one or more action labels corresponding to the natural language description of the requested data pipeline in a format guided by the prompt template. One or more executable nodes in an executable node library are identified, each executable node corresponding to a respective action label in the MM response and configured to perform the data processing action associated with the respective action label. The operations further comprise generating a project template from the one or more executable nodes, wherein the project template comprises the one or more executable nodes and one or more connections associated with the one or more executable nodes. The requested data pipeline is then generated from the project template.

Example 48: The non-transitory computer-readable storage medium of example 47, wherein the sample answer of the prompt template further comprises, for each of the one or more action labels associated with the sample natural language description, a data source label identifying a data source on which the data processing action of the action label will operate, and the MM response further comprises one or more data source labels, each data source label associated with a respective one of the one or more action labels in the MM response.

Example 49: The non-transitory computer-readable storage medium of example 48, wherein two or more action labels in the MM response are associated with identical data source labels.

Example 50: The non-transitory computer-readable storage medium of any of examples 47-49, wherein the prompt template comprises additional processing examples, each additional processing example including an additional sample query and an additional sample answer.

Example 51: The non-transitory computer-readable storage medium of any of examples 47-50, wherein the operations further comprise, prior to receiving the natural language description, receiving, from a user, an initial natural language request, and querying the MM with the initial natural language request to generate the natural language description of the requested data pipeline.

Example 52: The non-transitory computer-readable storage medium of any of examples 47-51, wherein the operations further comprise generating the set of action labels on-the-fly based on a listing of available executable nodes in the executable node library.

Example 53: The non-transitory computer-readable storage medium of any of examples 47-52, wherein the operations further comprise generating a user interface to visualize the project template. The user interface provides a preview mode comprising the project template, wherein the preview mode visualizes the one or more executable nodes and the one or more connections associated with the one or more executable nodes.

Example 54: The non-transitory computer-readable storage medium of any of examples 47-53, wherein the operations further comprise updating, using a user interface, the project template based on additional information received from the user. The additional information comprises one or more edits associated with at least one parameter of the one or more executable nodes or the one or more connections associated with the one or more executable nodes.

Example 55: The non-transitory computer-readable storage medium of any of examples 47-54, wherein at least one of the set of action labels, one or more processing examples, or the one or more executable nodes are pre-defined in a database.

Example 56: The non-transitory computer-readable storage medium of example 55, wherein the operations further comprise updating the database by adding, to the database, at least one of a new action label, a new processing example, or a new executable node.

Example 57: The non-transitory computer-readable storage medium of any of examples 55-56, wherein the operations further comprise updating the database by deleting, from the database, at least one of the one or more action labels, the one or more processing examples, or the one or more executable nodes.

Example 58: The non-transitory computer-readable storage medium of any of examples 47-57, wherein the identifying operation comprises parsing the MM response to extract the one or more action labels, determining, for each extracted action label, a correlation between the extracted action label and the one or more executable nodes, and selecting, from the executable node library for each extracted action label, a respective one of the one or more executable nodes correlating to the extracted action label or a default executable node based on the correlation between the extracted action label and the one or more executable nodes being low.

Example 59: The non-transitory computer-readable storage medium of any of examples 47-58, wherein the one or more executable nodes collectively identify at least two types of data processing actions of the data pipeline.

Example 60: A non-transitory computer-readable storage medium having instructions stored thereon that, when executed by one or more processing devices, cause the one or more processing devices to perform operations comprising receiving, by a multimodal model (MM) from a third party system, a query comprising a natural language description of a requested data pipeline and a prompt template. The prompt template comprises a set of action labels and a processing example, each action label in the set of action labels indicates a respective data processing action, and the processing example includes a sample query comprising a sample natural language description of a sample data pipeline and a sample answer comprising one or more sample action labels associated with the sample natural language description of the sample data pipeline, each of the one or more sample action labels being included in the set of action labels. The operations further comprise generating, by the MM, a query response comprising one or more action labels corresponding to the natural language description of the requested data pipeline in a format guided by the prompt template. The query response is then sent to the third party system.

Example 61: The non-transitory computer-readable storage medium of example 60, wherein the generating the query response operation further comprises generating one or more data source labels, each data source label associated with a respective action label and identifying a data source on which the data processing action of the respective action label will operate.

Example 62: The non-transitory computer-readable storage medium of example 61, wherein two or more action labels in the MM response are associated with identical data source labels.

Example 63: The non-transitory computer-readable storage medium of any of examples 60-62, wherein the prompt template received by the MM comprises additional processing examples, each additional processing example including an additional sample query and an additional sample answer.

Example 64: The non-transitory computer-readable storage medium of any of examples 60-63, wherein the operations further comprise, prior to the receiving receiving, by the MM from the third party system, an initial query comprising an initial natural language description of the requested data pipeline, generating, by the MM, an initial query response comprising the natural language description of the requested data pipeline, and sending the natural language description of the requested data pipeline to the third party system.

Example 65: The non-transitory computer-readable storage medium of example 64, wherein the initial query response comprises at least one of a spelling error correction, a typographical error correction, or a more detailed expression of the initial natural language description.

Example 66: A non-transitory computer-readable storage medium having

instructions stored thereon that, when executed by one or more processing devices, cause the one or more processing devices to perform operations comprising rendering, on a display of a user device, an input field of a graphical user interface, receiving, from a user via the input field, a natural language description of a requested data pipeline, and rendering, on the display of the user device, a project template comprising one or more executable nodes in the requested data pipeline, each of the one or more executable nodes identified from a multimodal model (MM) response comprising corresponding action labels indicating a respective executable node's data processing action, wherein the project template comprises the one or more executable nodes and one or more connections associated with the one or more executable nodes.

Example 67: The non-transitory computer-readable storage medium of example 66, wherein the operations further comprise receiving, from the user, at least one of an updated parameter or an updated connection associated with at least one of the one or more executable nodes, and rendering, on the display of the user device, an updated project template comprising the one or more executable nodes in the requested data pipeline based on the at least one updated parameter or updated connection.

Example 68: The non-transitory computer-readable storage medium of any of examples 66-67, wherein the operations for rendering the project template comprise rendering the project template in an object-based interactive area of the display of the user device.

Example 69: The non-transitory computer-readable storage medium of any of examples 66-68, wherein the operations further comprise rendering, on the display of the user device, a visualization of data being processed through the requested data pipeline via the project template based on the one or more executable nodes and the one or more connections.

Example 70: A system comprises an executable node library comprising a set of executable nodes, each executable node in the set of executable nodes comprising instructions corresponding to a respective data processing action. The system further comprises a graphical user interface configured to render, on a display of a user device, an input field, receive, from a user via the input field, a natural language description of a requested data pipeline, render, on the display of the user device, a project template comprising one or more executable nodes from the set of executable nodes in the requested data pipeline, and receive, from a user, an instruction to generate the requested data pipeline. The system further comprises a runtime stage configured to generate a model prompt comprising the received natural language description and a prompt template. The prompt template comprises a set of action labels and a processing example, each action label in the set of action labels indicates a respective data processing action, and the processing example includes a sample query comprising a sample natural language description of a sample data pipeline and a sample answer comprising one or more sample action labels associated with the sample natural language description of the sample data pipeline, each of the one or more sample action labels being included in the set of action labels. The runtime stage is further configured to query a multimodal model (MM) with the model prompt and receive an MM response from the MM, wherein the MM response comprises one or more action labels corresponding to the natural language description of the requested data pipeline in a format guided by the prompt template. The runtime stage is further configured to identify one or more executable nodes from the set of executable nodes in the executable node library, each executable node in the one or more executable nodes corresponding to a respective action label in the MM response and configured to perform the data processing action associated with the respective action label. The runtime stage is further configured to generate the project template from the one or more executable nodes, wherein the project template comprises the one or more executable nodes and one or more connections associated with the one or more executable nodes. The runtime stage is then configured to generate the requested data pipeline from the project template.

Example 71: The system of example 70, wherein the sample answer of the prompt template further comprises, for each of the one or more action labels associated with the sample natural language description, a data source label identifying a data source on which the data processing action of the action label will operate, and the MM response further comprises one or more data source labels, each data source label associated with a respective one of the one or more action labels in the MM response.

Example 72: The system of example 71, wherein two or more action labels in the MM response are associated with identical data source labels.

Example 73: The system of any of examples 70-72, wherein the prompt template comprises additional processing examples, each additional processing example including an additional sample query and an additional sample answer.

Example 74: The system of any of examples 70-73, wherein the runtime stage is further configured to generate the set of action labels on-the-fly based on a listing of available executable nodes in the executable node library.

Example 75: The system of any of examples 70-74, wherein the graphical user interface is further configured to generate a preview visualization comprising the project template, wherein the preview visualization visualizes the one or more executable nodes and the one or more connections associated with the one or more executable nodes.

Example 76: The system of any of examples 70-75, wherein the graphical user interface is further configured to receive additional information from the user. The additional information comprises one or more edits associated with at least one parameter of the one or more executable nodes or the one or more connections associated with the one or more executable nodes. The runtime stage is further configured to update the project template based on the additional information received from the user.

Example 77: The system of any of examples 70-76, further comprises a database comprising at least one of the set of action labels, one or more processing examples, or the executable node library.

Example 78: The system of example 77, wherein the runtime stage is further configured to update the database by adding, to the database, at least one of a new action label, a new processing example, or a new executable node.

Example 79: The system of any of examples 77-78, wherein the runtime stage is further configured to update the database by deleting, from the database, at least one of the one or more action labels, the one or more processing examples, or the one or more executable nodes.

Example 80: The system of any of examples 77-79, further comprises a pre-processing stage configured to generate at least one of the set of action labels or one or more processing examples, and store the at least one of the set of action labels or the one or more processing examples in the database for retrieval by the runtime stage.

Example 81: The system of example 80, wherein the database stores one or more pre-defined data pipelines, and the pre-processing stage is configured to automatically generate the at least one of the set of action labels or the one or more processing examples from the one or more pre-defined data pipelines.

Example 82: The system of any of examples 80-81, wherein the pre-processing stage is further configured to automatically generate the set of action labels from the set of executable nodes in the executable node library.

Example 83: The computer-implemented method of any of examples 1-23, wherein the MM is a large language model.

Example 84: The system of any of examples 24-46 and 70-82, wherein the MM is a large language model.

Example 85: The non-transitory computer-readable storage medium of any of examples 47-69, wherein the MM is a large language model.

Example 86: The computer-implemented method of any of examples 1-13, wherein the generating the requested data pipeline comprises generating software code that, when executed, performs the requested data pipeline by combining, as provided in the project template, the one or more executable nodes configured to perform respective data processing actions.

Example 87: The system of any of examples 24-36, wherein the generating the requested data pipeline comprises generating software code that, when executed, performs the requested data pipeline by combining, as provided in the project template, the one or more executable nodes configured to perform respective data processing actions.

Example 88: The non-transitory computer-readable storage medium of any of examples 47-59, wherein the generating the requested data pipeline comprises generating software code that, when executed, performs the requested data pipeline by combining, as provided in the project template, the one or more executable nodes configured to perform respective data processing actions.

It is to be appreciated that the Detailed Description section, and not any other section, is intended to be used to interpret the claims. Other sections can set forth one or more but not all exemplary aspects as contemplated by the inventor(s), and thus, are not intended to limit this disclosure or the appended claims in any way.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative aspects can perform functional blocks, steps, operations, methods, etc. using orderings different than those described herein.

References herein to “one aspect,” “an aspect,” “an example aspect,” or similar phrases, indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein. Additionally, some aspects can be described using the expression “coupled” and “connected” along with their derivatives. These terms are not necessarily intended as synonyms for each other. For example, some aspects can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary aspects, but should be defined only in accordance with the following claims and their equivalents.

What is claimed is:

1. A computer-implemented method performed by one or more computing devices, comprising:
receiving a natural language description of a requested data pipeline;
generating a model prompt comprising the received natural language description and a prompt template, wherein:
the prompt template comprises a set of action labels and a processing example,
each action label in the set of action labels indicates a respective data processing action, and
the processing example includes a sample query comprising a sample natural language description of a sample data pipeline and a sample answer comprising one or more sample action labels associated with the sample natural language description of the sample data pipeline, each of the one or more sample action labels being included in the set of action labels;
querying a multimodal model (MM) with the model prompt;
receiving an MM response from the MM, wherein the MM response comprises one or more action labels corresponding to the natural language description of the requested data pipeline in a format guided by the prompt template;
identifying one or more executable nodes in an executable node library, each executable node corresponding to a respective action label in the MM response and configured to perform the data processing action associated with the respective action label;
generating a project template from the one or more executable nodes, wherein the project template comprises the one or more executable nodes and one or more connections associated with the one or more executable nodes; and
generating the requested data pipeline from the project template.

2. The computer-implemented method of claim 1, wherein the generating the requested data pipeline comprises generating software code that, when executed, performs the requested data pipeline by combining, as provided in the project template, the one or more executable nodes configured to perform respective data processing actions.

3. The computer-implemented method of claim 1, wherein:
the sample answer of the prompt template further comprises, for each of the one or more action labels associated with the sample natural language description, a data source label identifying a data source on which the data processing action of the action label will operate, and
the MM response further comprises one or more data source labels, each data source label associated with a respective one of the one or more action labels in the MM response.

4. The computer-implemented method of claim 3, wherein two or more action labels in the MM response are associated with identical data source labels.

5. The computer-implemented method of claim 1, wherein the prompt template comprises additional processing examples, each additional processing example including an additional sample query and an additional sample answer.

6. The computer-implemented method of claim 1, further comprising, prior to receiving the natural language description:
receiving, from a user, an initial natural language request; and
querying the MM with the initial natural language request to generate the natural language description of the requested data pipeline.

7. The computer-implemented method of claim 1, further comprising generating the set of action labels on-the-fly based on a listing of available executable nodes in the executable node library.

8. The computer-implemented method of claim 1, further comprising:
generating a user interface to visualize the project template, wherein the user interface provides a preview mode comprising the project template, wherein the preview mode visualizes the one or more executable nodes and the one or more connections associated with the one or more executable nodes.

9. The computer-implemented method of claim 1, wherein at least one of the set of action labels, one or more processing examples, or the one or more executable nodes are pre-defined in a database.

10. The computer-implemented method of claim 9, further comprising updating the database by adding, to the database, at least one of a new action label, a new processing example, or a new executable node.

11. The computer-implemented method of claim 9, further comprising updating the database by deleting, from the database, at least one of the one or more action labels, the one or more processing examples, or the one or more executable nodes.

12. The computer-implemented method of claim 1, wherein the identifying comprises:
parsing the MM response to extract the one or more action labels;
determining, for each extracted action label, a correlation between the extracted action label and the one or more executable nodes; and
selecting, from the executable node library for each extracted action label, a respective one of the one or more executable nodes correlating to the extracted action label or a default executable node based on the correlation between the extracted action label and the one or more executable nodes being low.

13. The computer-implemented method of claim 1, wherein the one or more executable nodes collectively identify at least two types of data processing actions of the data pipeline.

14. A system, comprising:
one or more processors; and
a memory having instructions stored thereon that, when executed by the one or more processors, cause the one or more processors to perform operations comprising:
receiving a natural language description of a requested data pipeline;
generating a model prompt comprising the received natural language description and a prompt template, wherein:
the prompt template comprises a set of action labels and a processing example,
each action label in the set of action labels indicates a respective data processing action, and
the processing example includes a sample query comprising a sample natural language description of a sample data pipeline and a sample answer comprising one or more sample action labels associated with the sample natural language description of the sample data pipeline, each of the one or more sample action labels being included in the set of action labels;
querying a multimodal model (MM) with the model prompt;
receiving an MM response from the MM, wherein the MM response comprises one or more action labels corresponding to the natural language description of the requested data pipeline in a format guided by the prompt template;
identifying one or more executable nodes in an executable node library, each executable node corresponding to a respective action label in the MM response and configured to perform the data processing action associated with the respective action label;
generating a project template from the one or more executable nodes, wherein the project template comprises the one or more executable nodes and one or more connections associated with the one or more executable nodes; and
generating the requested data pipeline from the project template.

15. The system of claim 14, wherein:
the sample answer of the prompt template further comprises, for each of the one or more action labels associated with the sample natural language description, a data source label identifying a data source on which the data processing action of the action label will operate, and
the MM response further comprises one or more data source labels, each data source label associated with a respective one of the one or more action labels in the MM response.

16. The system of claim 14, wherein the operations further comprise, prior to receiving the natural language description:
receiving, from a user, an initial natural language request; and
querying the MM with the initial natural language request to generate the natural language description of the requested data pipeline.

17. The system of claim 14, wherein the operations further comprise:
generating a user interface to visualize the project template, wherein the user interface provides a preview mode comprising the project template, wherein the preview mode visualizes the one or more executable nodes and the one or more connections associated with the one or more executable nodes.

18. The system of claim 14, wherein the operations further comprise:
updating, using a user interface, the project template based on additional information received from the user, wherein the additional information comprises one or more edits associated with at least one parameter of the one or more executable nodes or the one or more connections associated with the one or more executable nodes.

19. The system of claim 14, wherein the identifying operation comprises:
parsing the MM response to extract the one or more action labels;
determining, for each extracted action label, a correlation between the extracted action label and the one or more executable nodes; and
selecting, from the executable node library for each extracted action label, a respective one of the one or more executable nodes correlating to the extracted action label or a default executable node based on the correlation between the extracted action label and the one or more executable nodes being low.

20. A non-transitory computer-readable storage medium having instructions stored thereon that, when executed by one or more processing devices, cause the one or more processing devices to perform operations comprising:
receiving a natural language description of a requested data pipeline;
generating a model prompt comprising the received natural language description and a prompt template, wherein:
the prompt template comprises a set of action labels and a processing example,
each action label in the set of action labels indicates a respective data processing action, and
the processing example includes a sample query comprising a sample natural language description of a sample data pipeline and a sample answer comprising one or more sample action labels associated with the sample natural language description of the sample data pipeline, each of the one or more sample action labels being included in the set of action labels;
querying a multimodal model (MM) with the model prompt;
receiving an MM response from the MM, wherein the MM response comprises one or more action labels corresponding to the natural language description of the requested data pipeline in a format guided by the prompt template;
identifying one or more executable nodes in an executable node library, each executable node corresponding to a respective action label in the MM response and configured to perform the data processing action associated with the respective action label;
generating a project template from the one or more executable nodes, wherein the project template comprises the one or more executable nodes and one or more connections associated with the one or more executable nodes; and
generating the requested data pipeline from the project template.
